(19) United States
(12) Patent Application Publication
(10) Pub. No.: US 2026/0346189 A1
(43) Pub. Date: Nov. 5, 2026

(54) IMMOBILIZED SOLVENT CARBON CAPTURE SYSTEM FOR STATIONARY AND MOBILE CARBON CAPTURE

(71) Applicant: OPTIMABIOME LLC, Germantown, MD (US)

(72) Inventor: Malcom FABIYI, Germantown, MD (US)

(21) Appl. No.: 19/704,107

(22) Filed: Jun. 10, 2026

Related U.S. Application Data
(63) Continuation of application No. PCT/US2025/039617, filed on Jul. 29, 2025.
(60) Provisional application No. 63/730,084, filed on Dec. 10, 2024.
(60) Provisional application No. 63/745,357, filed on Jan. 15, 2025.

(51) Int. Cl. B01D 53/14; B01D 51/10; B01D 53/04; B01D 53/18; B01D 53/26; B01D 53/62; B01D 53/80; B01J 20/04; B01J 20/22; B01J 20/28; B01J 20/34

(52) U.S. Cl. CPC B01D 53/1493; B01D 51/10; B01D 53/0438; B01D 53/0446; B01D 53/0454; B01D 53/1425; B01D 53/1475; B01D 53/18; B01D 53/265; B01D 53/62; B01D 53/80; B01J 20/041; B01J 20/22; B01J 20/28004; B01J 20/28016; B01J 20/28033; B01J 20/28071; B01J 20/3425; B01J 20/3433; B01J 20/3483; B01D 2251/304; B01D 2251/306; B01D 2251/404; B01D 2251/604; B01D 2251/606; B01D 2252/20415; B01D 2252/20484; B01D 2252/602; B01D 2253/106; B01D 2253/11; B01D 2253/20; B01D 2253/25; B01D 2253/304; B01D 2257/504; B01D 2257/80; B01D 2259/40088

(57) ABSTRACT

Disclosed is a carbon dioxide capture composition having a solid matrix formed from a porous solid sorbent material and a liquid solvent. The porous solid sorbent material has an oil absorption number of at least about 10 mL/100 g and the liquid solvent has a sorption capacity of at least about 2.5 g CO₂/L at 25 °C. The liquid solvent is from about 10 percent to about 90 percent of the mass of the matrix.

### RELATED CASES

This application is a continuation of International Application No. PCT/US2025/039617, filed on Jul. 29, 2025, which claims priority to U.S. Patent Application No. 63/745,357, filed on Jan. 15, 2025, and U.S. Patent Application No. 63/730,084, filed on Dec. 10, 2024; which are both incorporated herein in their entirety.

### BACKGROUND OF THE DISCLOSURE

About 40 billion tons of carbon dioxide (CO₂) are emitted annually. Carbon dioxide capture and sequestration are critical for reducing the levels of CO₂ in the atmosphere and achieving global net zero goals. The target of net zero goals is to capture as much of the emissions which are being generated and/or remove some of the CO₂ that has already been emitted into the atmosphere such that no net increment to the inventory of CO₂ in the atmosphere occurs. The capacity for the removal of CO₂ from the atmosphere and the sequestration and storage of CO₂ assuring its stable and permanent removal from the atmosphere are important steps in ensuring that global temperature rise does not exceed the 1.5 to 2 °C increase that could drive a degree of warming that would potentially cause the crossing of climatic tipping point thresholds. Carbon Capture, Utilization and Storage (CCUS) is critical to achieving net zero targets.

Current methods for CO₂ capture, sequestration, and storage involve its removal, transportation as a compressed gas in pipelines or trucks, or as a cryogenic liquid; with eventual storage in systems such as basaltic rocks, deep saline aquifers or depleted oil & gas reserves, as well as being utilized in applications such as Enhanced Oil Recovery (EOR), and algae cultivation, etc.

However, existing CCUS technologies continue to be challenging and costly to implement. For instance, one of the issues mitigating against CCUS is the fact that transportation of the captured CO₂ requires access to pipeline infrastructure that is proximate to the carbon capture location. Prior to injection into the pipeline, the CO₂ will need to be purified and compressed prior to its injection into a transportation pipeline. Where pipeline infrastructure does not exist, the captured CO₂ might need to be compressed or in some cases, liquefied. The purification, compression and/or liquefaction steps require additional equipment and energy to be made available at the CO₂ capture point which increases parasitic energy load, cost, and process complexity.

There exists a need in the art for materials that afford both a high capacity for CO₂ capture as well as ease of recovery and which can be converted to useful materials.

### BRIEF SUMMARY OF THE TECHNOLOGY

The present technology relates to a solid matrix comprising at least one porous solid sorbent material and at least one liquid solvent, wherein the liquid solvent generally comprises between about 50 percent to about 70 percent of the solid matrix, by mass. The present technology further relates to a carbon-capture apparatus comprising the solid matrix and method of using the same. The present technology further relates to methods of making the solid matrix.

In an aspect, the disclosure provides a composition for CO₂ capture, the composition comprising: a solid matrix comprising: a porous solid sorbent material with an oil absorption number of at least about 10 mL/100 g; and a liquid solvent with a CO₂ sorption capacity of at least about 2.5 g CO₂/L at 25 °C, wherein the liquid solvent is from about 10 percent to about 90 percent of the mass of the solid matrix.

In an aspect, the disclosure provides a volume of the liquid solvent that is less than about 150%, about 125%, about 100%, about 75%, about 50%, about 40%, about 30%, about 20%, or about 10% the volume of the porous solid sorbent material, alternatively.

In an aspect, the disclosure provides a porous solid sorbent material that is selected from the group consisting of silica, zeolites, metal oxides, ion exchange resins, metal organic frameworks (MOFs), covalent organic frameworks (COFs), calcium silicate, sodium aluminosilicate, magnesium stearate, tricalcium phosphate, sodium bicarbonate, sodium ferrocyanide, potassium ferrocyanide, calcium ferrocyanide, calcium carbonate, magnesium carbonate, and phyllosilicates.

In an aspect, the disclosure provides a porous solid sorbent material that is selected from the group consisting of acrylic ester polymers, activated charcoal, alumina nanoparticles, aluminum phyllosilicates, attapulgite, ball clay, bentonite, calcite, calcium bentonite, calcium carbonate, calcium ferrocyanide, calcium silicate, carbon nanotubes, clay, covalent organic frameworks, diatomaceous earth, dolomite, feldspar, fly ash, fossilized plant materials, Fuller's earth, fumed silica, functionalized silica, Georgia white clay, gypsum, halloysite, hectorite, hormite, illite, ion exchange resins, kaolinite, magnesium carbonate, magnesium stearate, metal organic frameworks, metal oxides, mica, Monterey shale, montmorillonite, opal, palygorskite, perlite, polymeric absorbent resins, polymethyl methacrylate (PMMA), polystyrene divinyl benzene, polystyrene, porous alumina, porous silica, potassium ferrocyanide, pumice, quartz, saponite, sepiolite, silica nanoparticles, silica, slate, smectite, sodium aluminosilicate, sodium bentonite, sodium bicarbonate, sodium ferrocyanide, styrene divinylbenzene (SDB), synthetic zeolite, tobermorite, tricalcium phosphate, vermiculite, and zeolites.

In an aspect, the disclosure provides a porous solid sorbent material that is selected from the group consisting of metal organic frameworks (MOFs) and Covalent Organic Frameworks (COFs).

In an aspect, the disclosure provides a liquid solvent that is selected from the group consisting of 1-(2aminoethyl)-piperazine (AEP), 1,5-bis(methylamino)-3-oxapentane (BMAP), 1,5-diamino-3-oxapentane (DAOP), 2-(2-(1-methyl-1-ethylpropylamino) ethoxy) ethanol, 2-(2-aminoethoxy) ethanol, 2-(2-aminoethylamino) ethanol (AEEA), 2-(2-isopropylaminopropoxy) ethanol, 2-(2-tert-amylaminoethoxy) ethanol, 2-(2-tert-butylaminoethoxy) ethanol (TBEE), 2-(2-tert-butylaminopropoxy) ethanol, 2-amino-2-hydroxymethyl-1,3-propanediol (Tris), 2-amino-2-methyl-1-propanol (AMP), 2-n-propoxyethylamine, 2,3,4,5-tetrahydrothiophene-1,1-dioxide, 3,3′-iminodipropionitrile, 3-aminopropionitrile, aminoacetonitrile, amino-acid, bis(2-ethoxyethyl)amine, bis(2-methoxyethyl)amine, deep eutectic Solvents (DESs), diethyelenecarbonate solutions (potassium and sodium), diethanol amine (DEA), diethanyltramine, diethanolamine (DEA), diglycolamine (DGA), diisopropylamine (DIPA), dimethyldiethanolamine, dimethyl ether of polyethylene glycols (DEPG or DMEPEG), ethoxyethanolamine (EEA), ethoxyethanol-tertiarybutylamine (EETB), hydroxyethylenediamine (HEDA), hydroxyethyl-ethylenediamine (HEEDA), glycerol, hydroxides, ionic liquids, methanol, methyl monoethanol amine (MMEA), methylaminoethanol (MAE), methyldiethylamine (MDEA), N-hydroxyethylpiperazine (HEP), N-methyldiethanolamine (MDEA), N-methylethanolamine, N-methylpiperazine (MP), N-Methyl 2Pyrrolidone (NMP), piperazine (PZ), polyethylene glycol methyl isopropyl ethers (MPE), polyethylenimine (PEI), propylene carbonate, sulfolane, tetraethylenepentamine (TEPA), tetramethylene sulfone (TMS), 3-Aminopropyl)trimethoxysilane (APTS), 3-Aminopropyl)triethoxysilane (APTES), 3-[2-(2-aminoethylamino)ethylamino]propyltrimethoxysilane or 2-112-(3-trimethoxysilyl propylamino)ethylaminol ethylamine, 3-amino-3-(2-Aminoethylamino) propyltrimethoxysilane 1-propanol (AP) or propanolamine, (AEAPTMS), and triethanolamine (TEA).

1100131 In an aspect, the disclosure provides a liquid solvent that is selected from the group consisting of amines, alkanolamines, ammonia, ionic liquids, Deep Eutectic Solvents, bicarbonates, sulfolanes, amino acids, alkaline solutions, hydroxides, and combinations thereof. In an aspect, the disclosure provides a liquid solvent that is selected from the group consisting of monoethanolamine (MEA), diethanolamine, monomethanolamine, dimethanolamine, monopropanolamine, dipropanolamine, 2-amino-2-methyl-1-propanol (AMP), diethylenetriamine, triethanolamine, amidoximes, tri-amino silanes, and piperazine (PZ).

In an aspect, the disclosure provides a liquid solvent that is monoethanolamine (MEA). In an aspect, the disclosure provides a liquid solvent that is an aqueous solution with a hydroxide, wherein the hydroxide is selected from the group consisting of sodium hydroxide, potassium hydroxide, magnesium hydroxide, calcium hydroxide, cesium hydroxide, lithium hydroxide, and ammonium hydroxide.

In an aspect, the disclosure provides a liquid solvent that further comprises a CO₂ capture promoter.

In an aspect, the disclosure provides a composition that further comprises a humectant.

In an aspect, the disclosure provides a solid matrix that further comprises an anti-caking agent selected from the group consisting of magnesium carbonate, calcium carbonate, magnesium sulfate, silicon dioxide, magnesium stearate, calcium phosphate, sodium ferrocyanide, potassium ferrocyanide, tricalcium phosphate, powdered cellulose, sodium aluminosilicate, magnesium trisilicate, stearic acid, polydimethylsiloxane, phyllosilicate materials, and combinations thereof. In an aspect, the disclosure provides a composition that further comprises a hygroscopic sorbent selected from the group consisting of zinc chloride, calcium chloride, potassium hydroxide, sodium hydroxide, magnesium chloride, lithium chloride, iron chloride, copper nitrate, sodium nitrate, ammonium chloride, gold chloride, cellulose based carbon aerogels, Sodium polyacrylate, carboxymethyl cellulose, polyacrylamide, polyvinyl alcohol (PVA), polyethylene glycol (PEG), polyacrylic acid, polyvinylpyrrolidone, hydroxyethyl cellulose, poly N-isopropylacrylamide, poly 2-hydroxyethyl methacrylate and combinations thereof.

In an aspect, the disclosure provides a liquid solvent that is reactive with CO₂ to form a mineralized material within a pore of the porous solid sorbent material.

In an aspect, the disclosure provides a mineralized material within a pore of the porous solid sorbent material, wherein the mineralized material is a product of a reaction between the liquid solvent and CO₂.

In an aspect, the disclosure provides a mineralized material that is a carbamate or a carbonate.

n an aspect, the disclosure provides a volatilization temperature of the liquid solvent in the solid matrix that is less than the volatilization temperature of the liquid solvent out of the solid matrix.

In an aspect, the disclosure provides a recovery temperature of CO₂ captured by the liquid solvent in the solid matrix that is at least about 40 °C less than the recovery temperature of CO₂ captured by the liquid solvent out of the solid matrix.

In an aspect, the disclosure provides a volatilization temperature of liquid solvent in the solid matrix that is at least about 40 °C less than the volatilization temperature of liquid solvent out of the solid matrix.

In an aspect, the disclosure provides an oil absorption number of the porous solid sorbent material that is from about 50 mL/100 g to about 500 mL/100 g.

In an aspect, the disclosure provides an angle of repose of the composition that is less than about 30 degrees, alternatively less than about 32 degrees, alternatively less than about 34 degrees, alternatively less than about 36 degrees, alternatively less than about 38 degrees, alternatively less than about 40 degrees.

In an aspect, the disclosure provides a composition that consists essentially of the porous solid sorbent material and the liquid solvent.

In an aspect, the disclosure provides a composition that consists essentially of the porous solid sorbent material, the liquid solvent, and a mineralized material within a pore of the porous solid sorbent material, wherein the mineralized material is a product of a reaction between the liquid solvent and CO₂.

In an aspect, the disclosure provides an absorption time percentage of the composition that is at least about 80%, alternatively at least about 82%, alternatively at least about 84%, alternatively at least about 86%, alternatively at least about 88%, alternatively at least about 90%, or alternatively at least about 92%.

In an aspect, the disclosure provides a solid matrix that has an average granule diameter from about 0.005 mm to about 40 mm, about 0.05 mm to about 4 mm, about 0.1 mm to about 2 mm, about 0.2 mm to about 1 mm, or about 0.5 mm.

In an aspect, the disclosure provides a composition that is a thin film.

In an aspect, the disclosure provides a CO₂ sorption capacity of the solid matrix that is equal to or greater than the CO₂ sorption capacity of the liquid solvent out of the matrix.

In an aspect, the disclosure provides a liquid solvent that is at least about 55% the mass of the solid matrix, alternatively at least about 40%, about 45%, about 50%, about 60%, about 65%, about 70%, about 75%, about 80%, about 85%, or about 90% the mass of the solid matrix.

In another aspect, the disclosure provides a method of making the composition, the method comprising: combining the porous solid sorbent material with the liquid solvent; and mixing the combined porous solid sorbent material and liquid solvent to form the solid matrix.

In another aspect, the disclosure provides a device comprising an input port; an output port; and a first module interposed between the input port and the output port, the first module comprising a composition for CO₂ capture, the composition comprising: a solid matrix comprising: a porous solid sorbent material with an oil absorption number of at least about 10 mL/100 g; and a liquid solvent with a CO₂ sorption capacity of at least about 2.5 g CO₂/L at 25 °C, wherein the liquid solvent is between about 50 percent to about 70 percent by mass of the solid matrix.

In an aspect, the disclosure provides at least one sensor configured to monitor a CO₂ saturation state of the composition.

In an aspect, the disclosure provides an input port of the device that is connected to a carbon dioxide source.

In an aspect, the disclosure provides a carbon dioxide source that is selected from the group consisting of a biogas energy system, a combined heat and power flue gas system, a fossil-fuel powered heater, a boiler system, a diesel generator, a natural gas generator, and a heavy fuel oil power generator.

In an aspect, the disclosure provides a device that further comprises an expansion zone having a feature selected from the group consisting of a baffle, a fin, and a heat exchange medium; the expansion zone connected to the input port to reduce a temperature of a gas entering the first module and remove moisture from the gas entering the first module.

In an aspect, the disclosure provides a second module interposed between the input port and the output port, the second module comprising the composition; and a valve between the input port and the first and second modules, the valve configured to direct a flow of gas to the first module or the second module.

In another aspect, the disclosure provides a method of capturing carbon dioxide, the method comprising: passing a gas mixture comprising CO₂ through a solid matrix, the solid matrix of comprising a porous solid sorbent material with an oil absorption number of at least about 10 mL/100 g, and a liquid solvent with a CO₂ sorption capacity of at least about 2.5 g CO₂/L at 25 °C, wherein the liquid solvent is between about 10 percent to about 90 percent by mass of the solid matrix; and absorbing the CO₂ into the liquid solvent.

In an aspect, the disclosure provides forming a mineralized deposit in a pore of the porous solid sorbent material.

In an aspect, the disclosure provides a mineralized deposit that is a carbamate.

In an aspect, the disclosure provides a method further comprising the step of heating the solid matrix and releasing the CO₂ from the liquid solvent.

In certain aspects, the present technology relates to a composition comprising: a solid matrix comprising at least one porous solid sorbent material; and at least one liquid solvent, wherein the at least one liquid solvent is between about 50 percent to about 70 percent by mass of the solid matrix.

In a further aspect, the present technology relates to a composition comprising: a solid matrix comprising at least one porous solid sorbent material; and at least one liquid solvent, wherein the ratio of the at least one solid sorbent material to the at least one liquid solvent is at least 1.0 by volume.

In a further aspect, the present technology relates to a composition comprising: a solid matrix comprising at least one porous solid sorbent material; and at least one liquid solvent, wherein the at least one solid sorbent material is selected from the group consisting of silica, Zeolites, metal oxides, ion exchange resins, metal organic frameworks, covalent organic frameworks, calcium silicate, sodium aluminosilicate, magnesium stearate, tricalcium phosphate, sodium bicarbonate, sodium ferrocyanide, potassium ferrocyanide, calcium ferrocyanide, calcium carbonate, magnesium carbonate, and phyllosilicates such as attapulgite, calcium bentonite, sodium bentonite and others.

In a further aspect, the present technology relates to a composition comprising: a solid matrix comprising at least one porous solid sorbent material; and at least one liquid solvent, wherein the at least one solid sorbent material is a naturally occurring solid sorbent material. Alternatively, the at least one solid sorbent material is an engineered solid sorbent material. In a further aspect, the present technology relates to a composition comprising: a solid matrix comprising at least one porous solid sorbent material; and at least one liquid solvent, wherein the at least one solid sorbent are polymeric materials.

In a further aspect, the present technology relates to a composition comprising: a solid matrix comprising at least one porous solid sorbent material; and at least one liquid solvent, wherein the at least one solid sorbent are microporous, mesoporous or microporous silica materials.

In a further aspect, the present technology relates to a composition comprising: a solid matrix comprising at least one porous solid sorbent material; and at least one liquid solvent, wherein the at least one solid sorbent are zeolites.

In a further aspect, the present technology relates to a composition comprising: a solid matrix comprising at least one porous solid sorbent material; and at least one liquid solvent, wherein the at least one solid sorbent are alkali metal adsorbents.

In a further aspect, the present technology relates to a composition comprising: a solid matrix comprising at least one porous solid sorbent material; and at least one liquid solvent, wherein the at least one solid sorbent are metal oxides.

In a further aspect, the present technology relates to a composition comprising: a solid matrix comprising at least one porous solid sorbent material; and at least one liquid solvent, wherein the at least one solid sorbent material are metal organic frameworks (MOFs) or Covalent Organic Frameworks (COFs).

In a further aspect, the present technology relates to a composition comprising: a solid matrix comprising at least one porous solid sorbent material; and at least one liquid solvent, wherein the at least one liquid solvent is selected from the group consisting of amines, alkanolamines, ammonia, ionic liquids, Deep Eutectic Solvents, bicarbonates, sulfolane, amino acids, alkaline solutions, hydroxides, and combinations thereof.

In a further aspect, the present technology relates to a composition comprising: a solid matrix comprising at least one porous solid sorbent material; and at least one liquid solvent, wherein the at least one liquid solvent is an at least one amine, wherein the at least one amine is selected from the group consisting of monoethanolamine, diethanolamine, monomethanolamine, dimethanolamine, monopropanolamine, dipropanolamine, 2-amino-2-methyl-1-propanol, diethylenetriamine, triethanolamine, Piperazine, and combinations thereof. In certain aspects, the at least one amine is monoethanolamine.

In a further aspect, the present technology relates to a composition comprising: a solid matrix comprising at least one porous solid sorbent material; and at least one liquid solvent, wherein the at least one liquid solvent is an at least one hydroxide selected from the group consisting of sodium hydroxide, potassium hydroxide, magnesium hydroxide, calcium hydroxide, ammonium hydroxide, and combinations thereof.

In a further aspect, the present technology relates to a composition comprising: a solid matrix comprising at least one porous solid sorbent material; and at least one liquid solvent, wherein the at least one liquid solvent further comprises a CO₂ capture promoter.

In a further aspect, the present technology relates to a composition comprising: a solid matrix comprising at least one porous solid sorbent material; and at least one liquid solvent, wherein the composition further comprises a humectant.

In a further aspect, the present technology relates to a composition comprising: a solid matrix comprising at least one porous solid sorbent material; and at least one liquid solvent, wherein the matrix further comprises an anti-caking agent selected from the group consisting of magnesium carbonate, calcium carbonate, magnesium sulfate, silicon dioxide, magnesium stearate, calcium phosphate, sodium ferrocyanide, potassium ferrocyanide, tricalcium phosphate, powdered cellulose, sodium aluminosilicate, magnesium trisilicate, stearic acid, polydimethylsiloxane, phyllosilicate materials, and combinations thereof.

In a further aspect, the present technology relates to a composition comprising: a solid matrix comprising at least one porous solid sorbent material; and at least one liquid solvent, wherein the selection of the at least one liquid solvent allows for the formation of an at least one mineralized material within the pores of the at least one porous solid sorbent materials. In a still further aspect, the formation of the at least one mineralized material occurs when carbon dioxide is captured by the at least one solvent.

In a further aspect, the present technology relates to a composition comprising: a solid matrix comprising at least one porous solid sorbent material; and at least one liquid solvent, wherein the captured carbon dioxide is recovered from the at least one solvent at a reduced temperature.

In a further aspect, the present technology relates to a composition comprising: a solid matrix comprising at least one porous solid sorbent material; and at least one liquid solvent, wherein the at least one solvent is volatilized from the matrix at a reduced temperature.

In a further aspect, the present technology relates to a composition comprising: a solid matrix comprising at least one porous solid sorbent material; and at least one liquid solvent, wherein the di-(2-ethylhexyl) adipate absorption number of the sorbent used in the matrix ranges from about 10 mL per 100 g of sorbent to about 500 mL per 100 g of sorbent.

In a further aspect, the present technology relates to a composition comprising: a solid matrix comprising at least one porous solid sorbent material; and at least one liquid solvent, wherein matrix is further capable of capturing an additional material selected from the group consisting of NOx, SOx, CO, Hydrocarbons, moisture, and particulates, wherein x is 1-3. In a still further aspect, the solid matrix has a selectivity for CO₂ that is greater than 50% in the presence of the additional material.

In a further aspect, the present technology relates to a composition comprising a solid matrix comprising at least one porous solid sorbent material; and at least one liquid solvent, wherein the composition has a CO₂ capture specific energy of greater than 1 kg CO₂/kWh.

In a further aspect, the present technology relates to a composition comprising: a solid matrix comprising at least one porous solid sorbent material; and at least one liquid solvent, wherein the composition is capable of having captured CO₂ recovered from the composition.

In a further aspect, the present technology relates to a composition comprising: a solid matrix comprising at least one porous solid sorbent material; and at least one liquid solvent, wherein the CO₂ recovery exceeds 50% of a CO₂ capture capacity.

In a further aspect, the present technology relates to a composition comprising: a solid matrix comprising at least one porous solid sorbent material; and at least one liquid solvent, wherein the composition is capable of being re-used for CO₂ capture with a greater than 50% CO₂ capture efficiency.

In a further aspect, the present technology relates to a composition comprising: a solid matrix comprising at least one porous solid sorbent material; and at least one liquid solvent. In a still further aspect, the form of the composition is a thin film. In certain aspects, the form of the composition is printed.

In certain aspects, the present technology relates to a device comprising an input port; an output port; and at least one module comprising a solid matrix comprising at least one porous solid sorbent material and at least one liquid solvent interposed between the input port and the output port.

In a further aspect, the present technology relates to a device comprising an input port; an output port; and at least one module comprising a solid matrix comprising at least one porous solid sorbent material and at least one liquid solvent interposed between the input port and the output port, wherein the device further comprises at least one sensor configured to monitor a CO₂ saturation state of the composition.

In a further aspect, the present technology relates to a device comprising an input port; an output port; and at least one module comprising a solid matrix comprising at least one porous solid sorbent material and at least one liquid solvent interposed between the input port and the output port, wherein the device is installed in a mobile CO₂ generating apparatus.

In a further aspect, the present technology relates to a device comprising an input port; an output port; and at least one module comprising a solid matrix comprising at least one porous solid sorbent material and at least one liquid solvent interposed between the input port and the output port, wherein the mobile CO₂ generating apparatus is an internal combustion engine vehicle.

In a further aspect, the present technology relates to a device comprising an input port; an output port; and at least one module comprising a solid matrix comprising at least one porous solid sorbent material and at least one liquid solvent interposed between the input port and the output port, wherein the device is installed such that an exhaust gas from the internal combustion engine vehicle enters the input port.

In a further aspect, the present technology relates to a device comprising an input port; an output port; and at least one module comprising a solid matrix comprising at least one porous solid sorbent material and at least one liquid solvent interposed between the input port and the output port, wherein the device is connected to a stationary CO₂ generating apparatus. In certain aspects, the stationary CO₂ generating apparatus is selected from a biogas energy system, a combined heat and power flue gas system, fossil-fuel powered heater or boiler system, renewable energy powered energy system, diesel fuel powered generators, natural gas fuel powered generators, or heavy fuel oil power generators.

In a further aspect, the present technology relates to a device comprising an input port; an output port; and at least one module comprising a solid matrix comprising at least one porous solid sorbent material and at least one liquid solvent interposed between the input port and the output port, wherein the device is installed downstream from the stationary CO₂ generating apparatus combustion process.

In a further aspect, the present technology relates to a device comprising an input port; an output port; and at least one module comprising a solid matrix comprising at least one porous solid sorbent material and at least one liquid solvent interposed between the input port and the output port, wherein the temperature and/or moisture content of a gas entering the input port is controlled to maximize CO₂ capture efficiency.

In a further aspect, the present technology relates to a device comprising an input port; an output port; and at least one module comprising a solid matrix comprising at least one porous solid sorbent material and at least one liquid solvent interposed between the input port and the output port, wherein the at least one module comprising the solid matrix is configured to be replaced when the composition becomes saturated with CO₂.

In certain aspects, the present technology relates to a method of capturing carbon dioxide, the method comprising: passing a gas mixture comprising CO₂ through a solid matrix comprising at least one porous solid sorbent material; and at least one liquid solvent, wherein the at least one liquid solvent is between about 50 percent to about 70 percent by mass of the solid matrix; and allowing the CO₂ to absorb into the solvent.

In a further aspect, the present technology relates to a method of capturing carbon dioxide, the method comprising: passing a gas mixture comprising CO₂ through a solid matrix comprising at least one porous solid sorbent material; and at least one liquid solvent, wherein the method further comprises allowing the CO₂ to form at least one mineralized deposit in the pores of the at least one porous solid sorbent.

In a further aspect, the present technology relates to a method of capturing carbon dioxide, the method comprising: passing a gas mixture comprising CO₂ through a solid matrix comprising at least one porous solid sorbent material; and at least one liquid solvent, wherein the at least one mineralized deposit is safe to handle.

In a further aspect, the present technology relates to a method of capturing carbon dioxide, the method comprising: passing a gas mixture comprising CO₂ through a solid matrix comprising at least one porous solid sorbent material; and at least one liquid solvent, wherein the absorption of CO₂ into the solvent occurs along an Adsorption Isotherm or a Vapor-Liquid Equilibrium profile.

In a further aspect, the present technology relates to a method of capturing carbon dioxide, the method comprising: passing a gas mixture comprising CO₂ through a solid matrix comprising at least one porous solid sorbent material; and at least one liquid solvent, wherein the absorption of CO₂ results in a saturation of the composition.

In a further aspect, the present technology relates to a method of capturing carbon dioxide, the method comprising: passing a gas mixture comprising CO₂ through a solid matrix comprising at least one porous solid sorbent material; and at least one liquid solvent, wherein after the composition is saturated with CO₂ the composition is disposed of.

In a further aspect, the present technology relates to a method of capturing carbon dioxide, the method comprising: passing a gas mixture comprising CO₂ through a solid matrix comprising at least one porous solid sorbent material; and at least one liquid solvent, wherein after the composition is saturated with CO₂, the composition is regenerated by the removal of CO₂ from the composition.

In a further aspect, the present technology relates to a method of capturing carbon dioxide, the method comprising: passing a gas mixture comprising CO₂ through a solid matrix comprising at least one porous solid sorbent material; and at least one liquid solvent, wherein after the composition is saturated with CO₂, the composition is regenerated by the removal of CO₂ and volatilization of some or all of the solvent from the composition, followed by the reconstitution of the solid matrix from the porous sorbent material and recovered solvent.

### BRIEF SUMMARY OF THE DRAWINGS

FIG. 1A shows the results of an experiment passing 20 liters per hour (“LPH”) of CO₂ through a matrix with 2.5 parts silica per 1 part ethanolamine by volume.

FIG. 1B shows the results of an experiment passing 5 LPH of CO₂ through a matrix with 2.5 parts silica per 1 part ethanolamine by volume.

FIG. 1C shows the results of an experiment passing 10 LPH of CO₂ and 10 LPH N₂ through a matrix with 2.5 parts silica per 1 part ethanolamine by volume.

FIG. 1D shows the results of an experiment passing 5 LPH of CO₂ and 15 LPH N₂ through a matrix with 2.5 parts silica per 1 part ethanolamine by volume.

FIG. 2A shows the results of an experiment passing 20 LPH of CO₂ through a matrix with 2.25 parts silica per 1 part ethanolamine by volume.

1100951 FIG. 2B shows the results of an experiment passing 10 LPH of CO₂ through a matrix with 2.25 parts silica per 1 part ethanolamine by volume.

1100961 FIG. 2C shows the results of an experiment passing 5 LPH of CO₂ through a matrix with 2.25 parts silica per 1 part ethanolamine by volume.

FIG. 2D shows the results of an experiment passing 10 LPH of CO₂ and 10 LPH N₂ through a matrix with 2.25 parts silica per 1 part ethanolamine by volume.

FIG. 2E shows the results of an experiment passing 5 LPH of CO₂ and 15 LPH N₂ through a matrix with 2.25 parts silica per 1 part aqueous solution (by volume) with 4% w/w NaOH.

FIG. 3A shows the results of an experiment passing 20 LPH of CO₂ through a matrix with 3 parts silica per 1 part aqueous solution (by volume) with 4% w/w NaOH.

FIG. 3B shows the results of an experiment passing 10 LPH of CO₂ through a matrix with 3 parts silica per 1 part aqueous solution with 4% w/w NaOH.

FIG. 3C shows the results of an experiment passing 5 LPH of CO₂ through a matrix with 3 parts silica per 1 part aqueous solution (by volume) with 4% w/w NaOH.

FIG. 3D shows the results of an experiment passing 10 LPH of CO₂ and 10 LPH N₂ through a matrix with 3 parts silica per 1 part aqueous solution (by volume) with 4% w/w NaOH.

FIG. 3E shows the results of an experiment passing 5 LPH of CO₂ and 15 LPH N₂ through a matrix with 3 parts silica per 1 part aqueous solution (by volume) with 4% w/w NaOH.

FIG. 4A shows the results of an experiment passing 20 LPH of CO₂ through a matrix with 2.5 parts silica per 1 part 2-amino-2-methyl-1-propanol by volume.

FIG. 4B shows the results of an experiment passing 10 LPH of CO₂ through a matrix with 2.5 parts silica per 1 part 2-amino-2-methyl-1-propanol by volume.

FIG. 4C shows the results of an experiment passing 5 LPH of CO₂ through a matrix with 2.5 parts silica per 1 part 2-amino-2-methyl-1-propanol by volume.

FIG. 4D shows the results of an experiment passing 10 LPH of CO₂ and 10 LPH N₂ through a matrix with 2.5 parts silica per 1 part 2-amino-2-methyl-1-propanol by volume.

FIG. 4E shows the results of an experiment passing 5 LPH of CO₂ and 15 LPH N₂ through a matrix with 2.5 parts silica per 1 part 2-amino-2-methyl-1-propanol by volume.

FIG. 5A shows the results of an experiment passing 20 LPH of CO₂ through a matrix with 2.5 parts silica per 1 part diethanyltramine by volume.

FIG. 5B shows the results of an experiment passing 10 LPH of CO₂ through a matrix with 2.5 parts silica per 1 part diethanyltramine by volume.

FIG. 5C shows the results of an experiment passing 5 LPH of CO₂ through a matrix with 2.5 parts silica per 1 part diethanyltramine by volume.

FIG. 5D shows the results of an experiment passing 10 LPH of CO₂ and 10 LPH N₂ through a matrix with 2.5 parts silica per 1 part diethanyltramine by volume.

FIG. 5E shows the results of an experiment passing 5 LPH of CO₂ and 15 LPH N₂ through a matrix with 2.5 parts silica per 1 part diethanyltramine by volume.

FIG. 6A shows the results of an experiment passing 20 LPH of CO₂ through a matrix with 4.5 parts attapulgite per 1 part ethanolamine by volume.

FIG. 6B shows the results of an experiment passing 10 LPH of CO₂ through a matrix with 4.5 parts attapulgite per 1 part ethanolamine by volume.

FIG. 6C shows the results of an experiment passing 5 LPH of CO₂ through a matrix with 4.5 parts attapulgite per 1 part ethanolamine by volume.

FIG. 6D shows the results of an experiment passing 10 LPH of CO₂ and 10 LPH N₂ through a matrix with 4.5 parts attapulgite per 1 part ethanolamine by volume.

FIG. 6E shows the results of an experiment passing 5 LPH of CO₂ and 15 LPH N₂ through a matrix with 4.5 parts attapulgite per 1 part ethanolamine by volume.

FIG. 7A shows the results of an experiment passing 20 LPH of CO₂ through a matrix with 5.8 parts attapulgite per 1 part aqueous solution (by volume) with 45% w/w KOH.

FIG. 7B shows the results of an experiment passing 10 LPH of CO₂ through a matrix with 5.8 parts attapulgite per 1 part aqueous solution (by volume) with 45% w/w KOH.

FIG. 7C shows the results of an experiment passing 5 LPH of CO₂ through a matrix with 5.8 parts attapulgite per 1 part aqueous solution (by volume) with 45% w/w KOH.

FIG. 7D shows the results of an experiment passing 10 LPH of CO₂ and 10 LPH N₂ through a matrix with 5.8 parts attapulgite per 1 part aqueous solution with 45% w/w KOH.

FIG. 8A shows the results of a second experiment passing 20 LPH of CO₂ through a matrix with 3 parts silica per 1 part aqueous solution (by volume) with 4% w/w NaOH.

FIG. 8B shows the results of a second experiment passing 10 LPH of CO₂ through a matrix with 3 parts silica per 1 part aqueous solution (by volume) with 4% w/w NaOH.

FIG. 8C shows the results of a second experiment passing 5 LPH of CO₂ through a matrix with 3 parts silica per 1 part aqueous solution (by volume) with 4% w/w NaOH.

FIG. 8D shows the results of a second experiment passing 10 LPH of CO₂ and 10 LPH N₂ through a matrix with 3 parts silica per 1 part aqueous solution (by volume) with 4% w/w NaOH.

FIG. 8E shows the results of a second experiment passing 5 LPH of CO₂ and 15 LPH N₂ through a matrix with 3 parts silica per 1 part aqueous solution (by volume) with 4% w/w NaOH.

FIG. 9 shows the results of an experiment passing 20 LPH of CO₂ through a matrix with greater than 10 parts calcium carbonate per 1 part ethanolamine by volume.

FIG. 10 shows the results of an experiment passing 20 LPH of CO₂ through a matrix with greater than 5 parts bentonite per 1 part ethanolamine by volume.

FIG. 11 shows the results of an experiment passing 20 LPH of CO₂ through a matrix with greater than 16 parts sodium ferrocyanide decahydrate per 1 part ethanolamine by volume.

FIG. 12A shows the results of an experiment passing 20 LPH of CO₂ through a matrix with greater than 6.5 parts magnesium stearate per 1 part ethanolamine by volume.

FIG. 12B shows the results of an experiment passing 10 LPH of CO₂ and 10 LPH N₂ through a matrix with greater than 6.5 parts magnesium stearate per 1 part ethanolamine by volume.

FIG. 12C shows the results of an experiment passing 5 LPH of CO₂ and 15 LPH N₂ through a matrix with greater than 6.5 parts magnesium stearate per 1 part ethanolamine by volume.

FIG. 13A shows the results of an experiment passing 20 LPH of CO₂ through a matrix with 5 parts sepiolite per 1 part ethanolamine by volume.

FIG. 13B shows the results of an experiment passing 10 LPH of CO₂ through a matrix with 5 parts sepiolite per 1 part ethanolamine.

FIG. 13C shows the results of an experiment passing 5 LPH of CO₂ and 15 LPH N₂ through a matrix with 5 parts sepiolite per 1 part ethanolamine. by volume

FIG. 14A shows the results of an experiment passing 20 LPH of CO₂ through a matrix with 5 parts sepiolite per 1 part aqueous solution (by volume) with 45% w/w KOH.

FIG. 14B shows the results of an experiment passing 10 LPH of CO₂ through a matrix with 5 parts sepiolite per 1 part aqueous solution (by volume) with 45% w/w KOH.

FIG. 15 shows the results of an experiment desorbing CO₂ from a saturated matrix of 2.25 parts silica per 1 part ethanolamine by volume.

FIG. 16 shows the results of an experiment desorbing CO₂ from a saturated matrix of 2.5 parts silica per 1 part 2-amino-2-methyl-1-propanol by volume.

FIG. 17A shows the results of an experiment heating a matrix of 3 parts silica per 1 part aqueous solution (by volume) with 4% w/w NaOH to 100 °C for one hour.

FIG. 17B shows the results of an experiment heating a CO₂ saturated matrix of 3 parts silica per 1 aqueous solution (by volume) with 4% w/w NaOH to 100 °C for one hour.

### DETAILED DESCRIPTION

The present disclosure describes a composition for capturing and storing carbon dioxide from the air or from a process stream, a carbon dioxide capture apparatus comprising the same, and method of using said apparatus.

### I. INTRODUCTION

For the past two decades there has been extensive interest in the development of mobile carbon capture systems for the decarbonization of transportation vehicles. Numerous methods exist for the capture and sequestration of CO₂. Separation of CO₂ from a gas stream and its effective sequestration are necessary steps to the eventual transport of CO₂ to final utilization or storage locations. There are eight (8) broad methods for the separation, capture and sequestration of CO₂ and these include the use of approaches and tools such as solvents, ionic liquids, adsorbents, membranes, metal organic frameworks, and covalent organic frameworks, etc.

Solvent aided CO₂ capture is the most common method of CO₂ removal, whereby CO₂ is captured through chemisorption, physisorption, or a combination of the two. Typical solvents for CO₂ capture include Amines such as Monoethanolamine (MEA), carbonate solutions (potassium and sodium), alkaline solutions, sulfolane, and ionic liquids. Once the solvent is saturated with CO₂, the CO₂ can be recovered by thermal desorption and transported for storage or secondary use. However, these systems suffer from several limitations including low capture solvent content, low CO₂ saturation level, and the materials are not safe to handle.

There exists a need in the art for solvent aided CO₂ capture materials with high solvent content having high CO₂ saturation levels which are safe to handle.

The inventors discovered that solid CO₂ capture matrices with greater than 50 percent solvent content by mass could be formed by combining a liquid solvent adsorbed into a porous solid sorbent to produce a free-flowing solid that is safer to handle than conventional solvent aided CO₂ capture materials.

The inventors unexpectedly discovered that the compositions of the present disclosure have an unexpectedly high CO₂ selectivity and capture capacity.

### II. DEFINITIONS

Unless otherwise defined, all technical and scientific terms used herein have the same meaning as commonly understood by one of ordinary skill in the art to which the methods described herein belong. Any reference to standard methods refers to the most recent available version of the method at the time of filing of this disclosure unless otherwise indicated.

For any method disclosed herein that includes discrete steps, the steps may be conducted in any feasible order. And, as appropriate, any combination of two or more steps may be conducted simultaneously.

All headings are for the convenience of the reader and should not be used to limit the meaning of the text that follows the heading, unless so specified.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements.

By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. As an example, a CO₂ scrubbing composition consisting essentially of a porous solid sorbent material and a liquid solvent may also include a dye to change the color of the composition that does not materially affect the CO₂ capturing properties of the composition.

As used herein, the term “including” means, and is used interchangeably with, the phrase “including but not limited to.” As used herein, the term “such as” means, and is used interchangeably with, the phrase “such as, for example” or “such as but not limited.”

The terms “first,” “second,” “third,” and “fourth” are used here only to distinguish elements, features, or limitations. The terms “first,” “second,” “third,” and “fourth” in no way indicate a chronological order or a prioritization of elements, features, or limitations within a grouping of elements, features, or limitations. The terms “first,” “second,” “third,” and “fourth” are used to merely distinguish one element, feature, or limitation from another element, feature, or limitation. The recitation of a “second” element, feature, or limitation does not require there is a “first” element, feature, or limitation.

The singular form “a,” “an,” and “the” include plural referents unless the context clearly dictates otherwise. These articles refer to one or to more than one (i.e., to at least one). As used herein, the term “or” is generally employed in its usual sense including “and/or” unless the content clearly dictates otherwise. The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y and z.”

Where ranges are given, endpoints include all numbers subsumed within that range (e.g., 1 to 5 includes 1, 1.5, 2, 2.75, 3, π, 3.80, 4, 5, etc.). Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise. Herein, “up to” a number (for example, up to 50) includes the number (for example, 50). The term “in the range” or “within a range” (and similar statements) includes the endpoints of the stated range.

Reference throughout this specification to “one aspect,” “an aspect,” “certain aspects,” or “some aspects,” etc., means that a particular feature, configuration, composition, or characteristic described in connection with the aspect is included in at least one aspect of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more aspects.

Unless stated otherwise, all percentages of a solution described herein are percentages by mass. Unless stated otherwise, all ratios described herein are ratios by mass.

Unless other units are explicitly indicated (e.g., nM or U/mL), the term “concentration” as used herein refers to a mass per volume.

Unless otherwise indicated, all numbers expressing quantities of components, molecular weights, and so forth used in the specification and claims are to be understood as being modified in all instances by the term “about.” As used herein in connection with a measured quantity, the term “about” refers to that variation in the measured quantity as would be expected by the skilled artisan making the measurement and exercising a level of care commensurate with the objective of the measurement and the precision of the measuring equipment used. The term “about” as used in connection with a numerical value throughout the specification and the claims denotes an interval of accuracy, familiar and acceptable to a person skilled in the art. In general, such interval of accuracy is +/−10%. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The term “exemplary” means serving as a non-limiting example, instance, or illustration. As utilized herein, the terms “e.g.,” and “for example” set off lists of one or more non-limiting aspects, examples, instances, or illustrations.

As used herein, the term “substantially” refers to the qualitative condition of exhibiting total or near-total extent or degree of a characteristic or property of interest. Biological and chemical phenomena rarely, if ever, go to completion and/or proceed to completeness or achieve or avoid an absolute result. The term “substantially” is therefore used herein to capture the potential lack of completeness inherent in many biological and chemical phenomena. For example, “substantially” may refer to being within at least about 20%, alternatively at least about 10%, alternatively at least about 5% of a characteristic or property of interest.

As used herein, the term “angle of repose” of a granular material refers to the steepest angle of descent or dip relative to the horizontal plane on which the material can be piled without slumping. A material with a shallower angle of repose will generally be more freely flowing than a material with a higher angle of repose.

As used herein, the term “absorption time percentage” is the amount of time a CO₂ scrubber can capture 99% of CO₂ input into the scrubber divided by time needed for CO₂ scrubber to be saturated with CO₂. As an example, a CO₂ scrubber that can capture 99% of a 10 liter per hour CO₂ flow (at standard temperature and pressure) for one hour, and takes two hours to be saturated with CO₂ (at the same CO₂ flow rate and conditions), would have an absorption time percentage of 50%. A CO₂ scrubber that can capture 99% of the 10 liter per hour CO₂ flow (at standard temperature and pressure) for 99 minutes, and takes 100 minutes to be saturated under the same CO₂ flow (i.e., one additional minute), would have an absorption time percentage of 99%.

As used herein, a “solvent” is a liquid that reacts with CO₂, or otherwise significantly captures CO₂. An example of a solvent is monoethanolamine (MEA) that reacts with CO₂ to form carbamic acid. A solvent may be a single substance, such as monoethanolamine (MEA), diethanolamine (DEA), methyldiethanolamine (MDEA) or triethanolamine (TEA). A solvent may also be a combination of two or more substances, such as MEA and DEA. A solvent may also be “solution of a substance dissolved in another substance. As an example, the solvent may be sodium hydroxide dissolved in water that reacts with CO₂ to form sodium carbonate.

As used herein, the “CO₂ sorption capacity” is the amount of CO₂ contained in a solvent saturated with CO₂. Unless otherwise indicated, CO₂ sorption capacities are at about 25 °C. As examples, the CO₂ sorption capacity of MEA is about 70-100 g CO₂/L, the CO₂ sorption capacity of potassium carbonate is about 50-80 g CO₂/L, the CO₂ sorption capacity of piperazine is about 150-200 g CO₂/L, and the CO₂ sorption capacity of 2-amino-2-methyl-1-propanol is about 100-120 g CO₂/L.

As used herein, the terms “oil absorption number,” “OAN,” or “DOA number” mean the di-(2-ethylhexyl) adipate liquid absorption capacity of a material. International Standards Organization publication ISO19246: 2016 provides an exemplary method of measuring the OAN of a material.

As used, the phrase “recovery temperature” is the temperature at which a CO₂ saturated solvent releases 0.5% of the stored CO₂ in one minute at 1 atmosphere of pressure.

As used herein, a liquid solvent that is “in a matrix” refers to a solvent that has been bound to an adsorbent (e.g., bentonite) and a liquid solvent that is “out of the matrix” refers to a solution of pure solvent. When “in the matrix” and “out of the matrix” properties are compared, all other conditions (e.g., pressure) are held constant unless otherwise specified.

### III. CAPTURE MATRIX

The carbon capture system may include a CO₂ capture matrix that comprises a solvent adapted to capture CO₂ and an adsorbent. When mixed, the adsorbent and solvent form a flowable granules of a solid that may be incorporated into a canister adapted to receive a flow of gas containing CO₂. In some embodiments, the capture matrix consists of only the solvent and the adsorbent. In other embodiments, the capture matrix consists essentially of only the solvent, adsorbent, and other elements that do not significantly impact the CO₂ capture ability of the matrix (e.g., dyes that only change the color of the matrix).

In an exemplary embodiment, the solvent utilized to capture CO₂ is ethanolamine. In other embodiments, the solvent is 1-(2aminoethyl)-piperazine (AEP), 1,5-bis(methylamino)-3-oxapentane (BMAP), 1,5-diamino-3-oxapentane (DAOP), 2-(2-(1-methyl-1-ethylpropylamino) ethoxy) ethanol, 2-(2-aminoethoxy) ethanol, 2-(2-aminoethylamino) ethanol (AEE), 2-(2-isopropylaminopropoxy) ethanol, 2-(2-tert-amylaminoethoxy) ethanol, 2-(2-tert-butylaminoethoxy) ethanol (TBEE), 2-(2-tert-butylaminopropoxy) ethanol, 2-amino-2-hydroxymethyl-1,3-propanediol (Tris), 2-amino-2-methyl-1-propanol (AMP), 2-n-propoxyethylamine, 2,3,4,5-tetrahydrothiophene-1,1-dioxide, 3,3′-iminodipropionitrile, 3-aminopropionitrile, aminoacetonitrile, amino-acid, bis(2-ethoxyethyl)amine, bis(2-methoxyethyl)amine, deep eutectic Solvents (DESs), diethyelenecarbonate solutions (potassium and sodium), diethanol (DEA), diethylenetriamine, diethanolamine (DEA), diglycolamine (DGA), diisopropylamine (DIPA), dimethyldiethanolamine, dimethyl ether of polyethylene glycols (DEPG or DMEPEG), ethoxyethanolamine (EEA), ethoxyethanol-tertiarybutylamine (EETB), hydroxyethylenediamine (HEDA), hydroxyethyl-ethylenediamine (HEEDA), glycerol, hydroxides, ionic liquids, methanol, methyl monoethanol amine (MMEA), methylaminoethanol (MAE), methyldiethylamine (MDEA), N-hydroxyethylpiperazine (HEP), N-methyldiethanolamine (MDEA), N-methylethanolamine, N-methylpiperazine (MP), N-Methyl 2Pyrrolidone (NMP), piperazine (PZ), polyethylene glycol methyl isopropyl ethers (MPE), propylene carbonate, sulfolane, tetraethylenepentamine, polyethylenimine, tetramethylene sulfone (TMS), triethanolamine (TEA), or combinations thereof.

In other embodiments, an aqueous solution of KOH or NaOH is the solvent.

In other embodiments, an aqueous solution of cesium hydroxide, lithium hydroxide, magnesium hydroxide, or calcium hydroxide is the solvent.

In some embodiments, the solvent captures CO₂ through chemisorption, physisorption, or chemiphysisorption

In some embodiments, the solvent includes a CO₂ capture catalyst such as carbonic anhydrase, a metalloenzyme that enhances the reaction rate of CO₂ in the liquid phase. In some embodiments, humectants are mixed with the solvent.

In some embodiments, the solvent is about 4% weight-by-weight (“w/w”) NaOH in water, alternatively about 1%, about 1.5%, about 2%, about 2.5%, about 3%, about 3.5%, about 4.5%, or about 5% w/w NaOH in water. In some embodiments, the solvent is about 45% w/w KOH or NaOH in water, alternatively about 20%, about 25%, about 30%, about 35%, about 40%, about 45%, about 50%, about 55%, about 60%, about 65%, about 70%, or about 75% w/w KOH or NaOH in water.

In an exemplary embodiment, the solvent has a high CO₂ sorption capacity, fast sorption kinetics, high CO₂ selectivity, mild conditions for regeneration, tolerance to the presence of moisture and other impurities in the feed, and low cost. In an exemplary embodiment, about 10% of gas passed through the matrix is water vapor.

In an exemplary embodiment, the solvent has a CO₂ sorption capacity of at least about 40 g CO₂/L. In other embodiments, the solvent has a CO₂ sorption capacity of at least about 25 g CO₂/L, about 30 g CO₂/L, about 35 g CO₂/L, about 45 g CO₂/L, about 50 g CO₂/L, about 55 g CO₂/L, about 60 g CO₂/L, about 65 g CO₂/L, about 70 g CO₂/L, about 75 g CO₂/L, about 80 g CO₂/L, about 85 g CO₂/L, about 90 g CO₂/L, about 95 g CO₂/L, about 100 g CO₂/L, about 105 g CO₂/L, about 110 g CO₂/L, about 115 g CO₂/L, about 120 g CO₂/L, about 125 g CO₂/L, about 130 g CO₂/L, about 135 g CO₂/L, about 140 g CO₂/L, about 145 g CO₂/L, about 150 g CO₂/L, about 200 g CO₂/L, about 250 g CO₂/L, about 300 g CO₂/L, about 350 g CO₂/L, or about 400 g CO₂/L at 25 °C.

In one embodiment, the solvent is ethanolamine and has a CO₂ sorption capacity of about 70-100 g CO₂/L. In another embodiment, the solvent is potassium carbonate and has a CO₂ sorption capacity of about 50-80 g CO₂/L. In another embodiment, the solvent is piperazine and has a CO₂ sorption capacity of about 150-200 g CO₂/L. In another embodiment, the solvent is 1 molal NaOH and has a CO₂ sorption capacity of about 40-50 g CO₂/L. In another embodiment, the solvent is 2-Amino-2-Methyl-1-Propanol and has a CO₂ sorption capacity of about 100-120 g CO₂/L.

In an exemplary embodiment, the solvent is selected based on its 1) CO₂ capture/sorption capacity, 2) loading capacity in the adsorbent materials, 3) long and medium term stability of CO₂ capture, 4) efficiency of the solvent after regeneration, and 5) thermal energy required for regeneration.

In an exemplary embodiment, the adsorbent is silica. In other embodiments, the adsorbent is attapulgite, calcium carbonate, sodium ferrocyanide decahydrate, bentonite, silica, magnesium stearate, sepiolite, or combinations thereof.

In other embodiments, the adsorbent is acrylic ester polymers, activated charcoal, alumina nanoparticles, aluminum phyllosilicates, attapulgite, ball clay, bentonite, calcite, calcium bentonite, calcium carbonate, calcium ferrocyanide, calcium silicate, carbon nanotubes, clay, covalent organic frameworks, diatomaceous earth, dolomite, feldspar, fly ash, fossilized plant materials, Fuller's earth, fumed silica, functionalized silica, Georgia white clay, gypsum, halloysite, hectorite, hormite, illite, ion exchange resins, kaolinite, magnesium carbonate, magnesium stearate, metal organic frameworks, metal oxides, mica, Monterey shale, montmorillonite, opal, palygorskite, perlite, polymeric absorbent resins, polymethyl methacrylate (PMMA), polystyrene divinyl benzene, polystyrene, porous alumina, porous silica, potassium ferrocyanide, pumice, quartz, saponite, sepiolite, silica nanoparticles, silica, slate, smectite, sodium aluminosilicate, sodium bentonite, sodium bicarbonate, sodium ferrocyanide, styrene divinylbenzene (SDB), synthetic zeolite, tobermite, tricalcium phosphate, vermiculite, zeolites, or combinations thereof.

In some embodiments, the adsorbent is a porous material. In some embodiments, the adsorbent is a porous material with an average pore size of about 10 nm, about 20 nm, about 30 nm, about 40 nm, about 50 nm, about 75 nm, about 100 nm, about 125 nm, about 150 nm, about 200 nm, about 250 nm, about 300 nm, about 400 nm, about 500 nm, about 750 nm, about 1 tm, about 1.25 tm, about 1.5 tm, about 1.75 tm, about 2 tm, about 2.5 tm, about 3 tm, about 4 tm, about 5 tm, about 7.5 tm, about 10 tm, about 15 tm, about 20 tm, about 25 tm, about 50 tm, about 100 tm, about 150 tm, about 200 tm, about 250 tm, or about 300 tm.

In an exemplary embodiment, the adsorbent has a di-(2-ethylhexyl) adipate oil absorption number (“OAN” or “oil absorption number”) of at least about 100 mL/100 g. In other embodiments, the adsorbent has an OAN of at least about 10 mL/100 g, about 20 mL/100 g, about 30 mL/100 g, about 40 mL/100 g, about 50 mL/100 g, about 60 mL/100 g, about 70 mL/100 g, about 80 mL/100 g, about 90 mL/100 g, about 110 mL/100 g, about 120 mL/100 g, about 130 mL/100 g, about 140 mL/100 g, about 150 mL/100 g, about 160 mL/100 g, about 170 mL/100 g, about 180 mL/100 g, about 190 mL/100 g, about 200 mL/100 g, about 210 mL/100 g, about 220 mL/100 g, about 230 mL/100 g, about 240 mL/100 g, about 250 mL/100 g, about 260 mL/100 g, about 270 mL/100 g, about 280 mL/100 g, about 290 mL/100 g, about 300 mL/100 g, about 310 mL/100 g, about 320 mL/100 g, about 330 mL/100 g, about 340 mL/100 g, about 350 mL/100 g, about 360 mL/100 g, about 370 mL/100 g, about 380 mL/100 g, about 390 mL/100 g, about 400 mL/100 g, about 425 mL/100 g, about 450 mL/100 g, about 475 mL/100 g, or about 500 mL/100 g. Example OANs include 190 to 305 mL/100 g for silica, 120 to 200 mL/100 g for calcium silicate, and 50-150 mL/100 g for magnesium stearate. The OANs of some exemplary adsorbents are shown in table 1.

TABLE 1
Exemplary Adsorbents

| Adsorbent | Oil Absorption Number (mL/100 g) |
|---|---|
| SiO₂ - PPG Flo-Gard AB/AB-D | 305 |
| SiO₂ - PPG Flo-Gard SP | 265 |
| SiO₂ - PPG Flo-Gard LPC | 245 |
| SiO₂ - PPG 213 | 200 |
| Calcium Silicate | 120-200 |
| Magnesium Stearate | 50-150 |
| Tricalcium Phosphate | 50-100 |
| Sodium Bicarbonate | 50-70 |
| Calcium Carbonate | 30-50 |
| Sodium Aluminosilicate | 30-50 |
| Attapulgite | Up to 80 |

In some embodiments, the adsorbent has a high CO₂ sorption capacity. In one embodiment, the adsorbent is zeolite 13X and has a CO₂ sorption capacity of 50-60 g CO₂/L. In another embodiment, the adsorbent is activated carbon and has a CO₂ sorption capacity of 40-50 g CO₂/L. In another embodiment, the adsorbent is metal-organic frameworks (MOFs) and has a CO₂ sorption capacity of 80-100 g CO₂/L.

In an exemplary embodiment, the adsorbent has a high CO₂ sorption capacity, fast sorption kinetics, high CO₂ selectivity, mild conditions for regeneration, tolerance to the presence of moisture and other impurities in the feed, and low cost. In an exemplary embodiment, about 10% of gas passed through the matrix is water vapor.

In some embodiments, the matrix includes a superabsorbent agent or hygroscopic sorbent such as zinc chloride, calcium chloride, potassium hydroxide, sodium hydroxide, magnesium chloride, Lithium chloride, Iron chloride, copper nitrate, sodium nitrate, ammonium chloride, Gold chloride, Cellulose based Carbon aerogels, Sodium polyacrylate, Carboxymethyl Cellulose, Polyacrylamide, Polyvinyl Alcohol (PVA), Polyethylene Glycol (PEG), Polyacrylic Acid, Polyvinylpyrrolidone, Hydroxyethyl Cellulose, Poly N-isopropylacrylamide, Poly 2-hydroxyethyl methacrylate, or combinations thereof.

In an exemplary embodiment, the adsorbent is selected based on its 1) possession of anti-caking properties, 2) loading capacity of the sorbent (e.g., OAN), 3) mechanical stability (e.g., minimal dusting or degradation after prolonged use), 4) efficiency of sorbent after regeneration (e.g., effect of regeneration on hygroscopic capacity measured as OAN), 5) retention of liquid solvent after regeneration, and 6) thermal energy required for regeneration.

In some embodiments, the ratio of adsorbent to solvent, by volume is about 3:1. In other embodiments, the ratio of adsorbent to solvent by volume, is about 1:10, about 1:9, about 1:8, about 1:6, about 1:5, about 1:4, about 1:3.5 about 1:3, about 1:2.5, about 1:2.25, about 1:2, about 1:1.75, about 1:1.5, about 1:1.25, about 1:1, about 1.25:1, about 1.5:1, about 1.75:1, about 2:1, about 2.25:1, about 2.5:1, about 2.75:1, about 3:1, about 3.5:1, about 4:1, about 4.5:1, about 5:1, about 6:1, about 7:1, about 8:1, about 9:1, about 10:1, about 12:1, about 14:1, about 16:1, about 18:1, or about 20:1.

In some embodiments, the adsorbent is a metal oxide and the ratio, by volume, of adsorbent to solvent in the matrix is less than 1.0.

In an exemplary of a silica oxide ethanolamine matrix, the solvent (ethanolamine) is about 70% of the mass of the matrix. In other embodiments, the solvent is about 5%, about 10%, about 15%, about 20%, about 25%, about 30%, about 35%, about 40%, about 45%, about 50%, about 55%, about 60%, about 65%, about 75%, about 80%, about 85%, or about 90% of the total mass of the matrix composition.

In an exemplary embodiment, the matrix is in the form of granules, and the granules have an average diameter of about 0.2 mm. In other embodiments, the granules of the matrix have an average diameter of about 0.01 mm, about 0.02 mm, about 0.03 mm, about 0.04 mm, about 0.05 mm, about 0.1 mm, about 0.15 mm, about 0.25 mm, about 0.3 mm, about 0.4 mm, about 0.5 mm, about 0.6 mm, about 0.7 mm, about 0.8 mm, about 0.9 mm, about 1 mm, about 1.2 mm, about 1.4 mm, about 1.6 mm, about 1.8 mm, about 2 mm, about 2.5 mm, about 3 mm, about 3.5 mm, about 4 mm, about 4.5 mm, about 5 mm, about 6 mm, about 7 mm, about 8 mm, about 9 mm, or about 10 mm.

In an exemplary embodiment, when the adsorbent is mixed into the solvent the resulting matrix is a solid flowable powder that is dry to the touch despite having a substantial portion of its mass being a liquid solvent.

In some embodiments, the solvent and adsorbent are mixed. The solvents may be gradually introduced to the adsorbent while the adsorbent is moved with a mechanical means such as a mechanical stir or a drum mixer. Alternatively, the solvent may be sprayed or dripped onto the adsorbent, or adsorbent may be immersed in a solution of solvent. After the solvent has been added to the adsorbent, the combination may continue to be stirred in order to homogenize it. In alternative embodiment, the solvent is chemically bonded onto the surface of adsorbent. In an exemplary embodiment, an amine silane is used to bond an amine solvent onto the adsorbent. In another embodiment, the adsorbent is a polymer and the monomer of the adsorbent is mixed into the solvent. An initiator triggers the polymerization of the monomer of the adsorbent into the adsorbent polymer.

Following mixing of the solvent and adsorbent, the resulting matrix may be formed into particles, granules, beads, or pellets. The resulting matrix may also be pressed into a sheet.

In some embodiments, humectants are mixed with the adsorbent.

In an exemplary embodiment, the adsorbent/solvent matrix has an angle of repose of about 30 degrees. In other embodiments, the angle of repose of the matrix is about 20 degrees, about 21 degrees, about 22 degrees, about 23 degrees, about 24 degrees, about 25 degrees, about 26 degrees, about 27 degrees, about 28 degrees, about 29 degrees, about 31 degrees, about 32 degrees, about 33 degrees, about 34 degrees, about 35 degrees, about 36 degrees, about 37 degrees, about 38 degrees, about 39 degrees, or about 40 degrees.

In an exemplary embodiment, the matrix consists of only the adsorbent and the solvent. In another exemplary embodiment, the matrix consists essentially of the adsorbent and the solvent and does not contain anything that materially affects the characteristics or activity of the adsorbent and the solvent in the matrix. In other embodiments, such as after the solvent has reacted with CO₂, the matrix consists essentially of the adsorbent, the solvent, and a mineralized material that is the product of a reaction between the solvent and CO₂. In some embodiments, the mineralized material is a carbamate, and is located within the pores of a porous adsorbent. Characteristics of the adsorbent and the solvent in the matrix are shown in Table 2.

TABLE 2
Characteristics of Solvent and Adsorbent

| Solvent Characteristics | Adsorbent Characteristics |
|---|---|
| CO₂ sorption capacity is essential | CO₂ sorption capacity is not essential |
| sorption kinetics | sorption kinetics |
| CO₂ capture selectivity is essential | CO₂ selectivity is not essential |
| loading capacity into the adsorbent | conditions for regeneration |
| conditions for regeneration | tolerance to the presence of moisture and other |
| | impurities |
| tolerance to moisture and other impurities | possession of anti-caking, humectant and/or |
| | hygroscopic properties |
| long and medium term stability of CO₂ capture | loading capacity of solvent (e.g., OAN) |
| efficiency of the solvent after regeneration | mechanical stability |
| thermal energy required for regeneration | efficiency of sorbent after regeneration |
| | retention of liquid solvent after regeneration |

In an exemplary embodiment, the sorption kinetics of the matrix provide a highly efficient capture of CO₂ until the matrix nears CO₂ saturation at which point the capture of CO₂ rapidly declines (i.e., the matrix has a high absorption time percentage). In an exemplary embodiment, the matrix has an absorption time percentage of at least about 80% when 100% CO₂ gas is passed through the matrix. In other embodiments, the matrix has an absorption time percentage of at least about 50%, at least about 55%, at least about 60%, at least about 65%, at least about 70%, at least about 75%, at least about 85%, or at least about 90% when 100% CO₂ gas is passed through the matrix.

In an exemplary embodiment, the temperature needed to recover CO₂ from the matrix is substantially lower than the solvent alone. In one embodiment, recovery of CO₂ from a silica ethanolamine matrix occurs at about 50 °C less than would be needed for ethanolamine by itself. In another embodiment, the recovery of the CO₂ from the solvent in the matrix occurs at about 35 °C, about 40 °C, about 45 °C, about 55 °C, about 60 °C, about 65 °C, or about 70 °C lower than would occur in the solvent by itself out of the matrix.

In some embodiments, where the matrix generated carbonate solutions upon exposure to CO₂, the matrix may be recovered by applying a water stream to the spent matrix to dissolve the carbonate.

### IV. MOBILE CARBON CAPTURE SYSTEMS

The matrix may be packed into a container, or module, with an inlet configured to receive a gas containing CO₂ and an outlet to exhaust gas from which the CO₂ has been removed. In one embodiment, the inlet of the container is connected to the exhaust of an internal combustion engine. In some embodiments, there is about a 1 atm pressure drop between the inlet of the container and the outlet of the container. In some embodiments, the container enclosing the matrix is replaceable such that spent matrix can be removed from the system after it has been saturated, or substantially saturated, with CO₂. In some embodiments, multiple containers with matrix are connected, in parallel, to a source of CO₂ gas and a valve directs the flow of gas to a specific container. In certain embodiments, sensors on the container are used to detect the amount of CO₂ in a container's matrix. Once the level of CO₂ in the container's matrix exceeds a threshold level, the flow of gas is diverted to another container by the valve. In an exemplary embodiment, the mobile carbon capture system lacks a system for regenerating the matrix after it has been saturated with CO₂. In such a system, the matrix must be removed from the mobile system before it can be regenerated (i.e., regenerated at a stationary facility).

In some embodiments, such as a power plant, the spent module/container of matrix may be replaced with a new container of matrix while the flow of gas is being scrubbed by another container. In some embodiments, the multiple modules are connected in parallel to a CO₂ source. Between the CO₂ source and the modules may be a valve that selectively direct the flow of gas from the CO₂ source to one of the modules. The valve may direct the flow of gas away from a CO₂ saturated first module, and to a second module, so that the CO₂ saturated first module may be replaced with a new module capable of capturing CO₂.

In some embodiments, two or more containers with matrix are connected in series such that a first container removes a first portion of CO₂ from a gas and then a second portion of CO₂ is removed by the matrix in a second container.

After the matrix in a container has been saturated with CO₂, the container may be taken to a recovery station where the CO₂ is removed from the matrix such that the container and matrix may be used again. In some embodiments, after the matrix in a container has been saturated with CO₂, the container may be sealed and CO₂ gas may be pumped into the headspace of the container to limit the off gassing of CO₂ from the matrix. In some embodiments, CO₂ is removed from the matrix in the container by heating the container to a certain temperature. In alternative embodiments, the CO₂ saturated matrix within the container may be removed and the container filled with new matrix. In some embodiments, the spent matrix is stored in a long term storage facility.

### IV. EXAMPLES

### Example 1—Silica and Ethanolamine #1

Silica (SiO₂ PPG AB) and ethanolamine were obtained from commercial sources. A composition was prepared with 2.5 parts silica per 1 part ethanolamine, by volume, using the procedures previously described. The resulting matrix had a specific gravity of 0.75 g/mL. A 250 mm tall test cylinder with an internal diameter of 50 mm was packed with the composition. Test gases flowed through the test cylinder until the levels of CO₂ exiting the test cylinder reached a saturation level (e.g., flow gas was 25% CO₂ and detected CO₂ levels were 250,000 PPM). Flow rates of 20 liters per hour (LPH) CO₂, 5 LPH CO₂, 10 LPH CO₂+10 LPH N₂, and 5 LPH CO₂+15 LPH N₂ were tested.

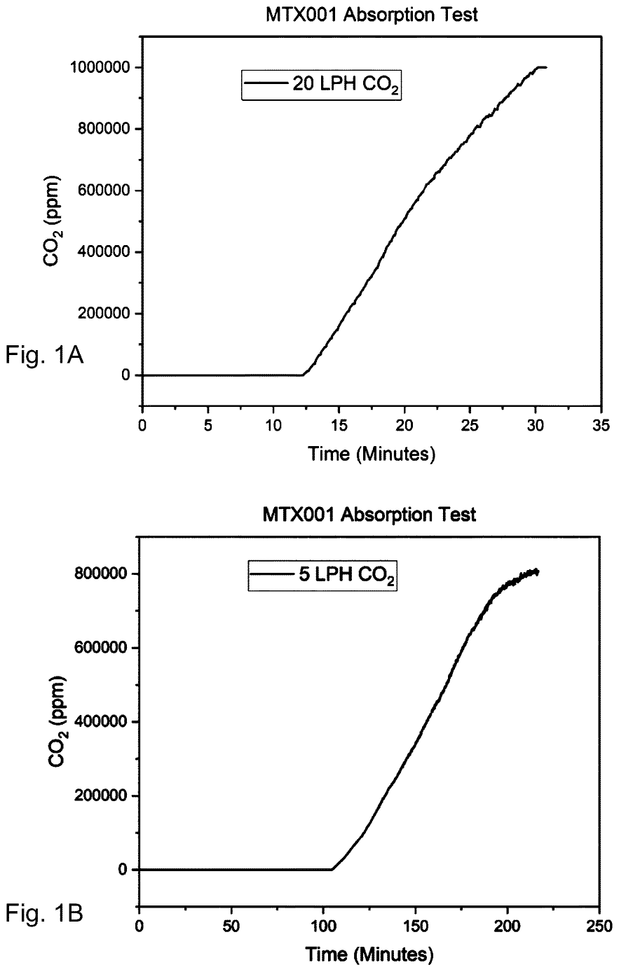

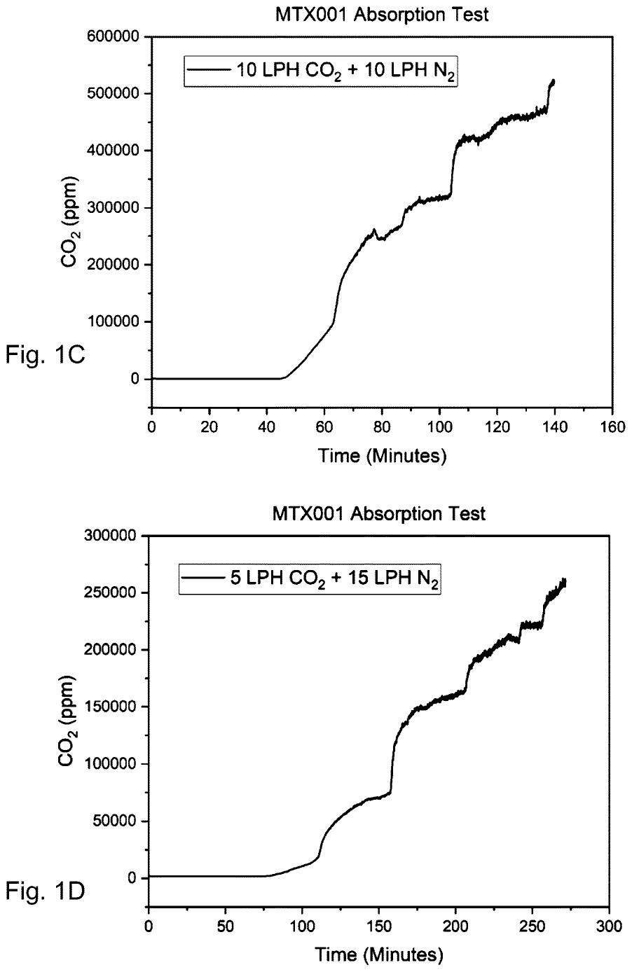

The results of the experiment are shown in FIGS. 1A through 1C.

The absorption time percentages of the 20 LPH CO₂, 5 LPH CO₂, 10 LPH CO₂+10 LPH N₂, and 5 LPH CO₂+15 LPH N₂ tests were found to be 40.9%, 48.2%, 32.7%, and 29.5%, respectively. In the 20 LPH CO₂ test, the measured CO₂ levels reached one million ppm (i.e., 100%) at 30.20 minutes. At 12.45 minutes, the measured CO₂ levels exceeded 1% of saturation (i.e., 10,000 ppm). The resulting absorption time percentage was 40.9% (12.45 minutes divided by 30.20 minutes equals 40.894%). The matrix was found to have captured about 80 grams of CO₂ per liter of matrix or about 0.11 grams of CO₂ per gram of matrix.

### Example 2—Silica and Ethanolamine #2

Silica (SiO₂ PPG AB) and ethanolamine were obtained from commercial sources. A composition was prepared with 2.25 parts silica per 1 part ethanolamine, by volume, using the procedures previously described. The resulting matrix had a specific gravity of 0.75 g/mL. A 250 mm tall test cylinder with an internal diameter of 50 mm was packed with the composition. Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂+10 LPH N₂, and 5 LPH CO₂+15 LPH N₂ through the cylinder were tested.

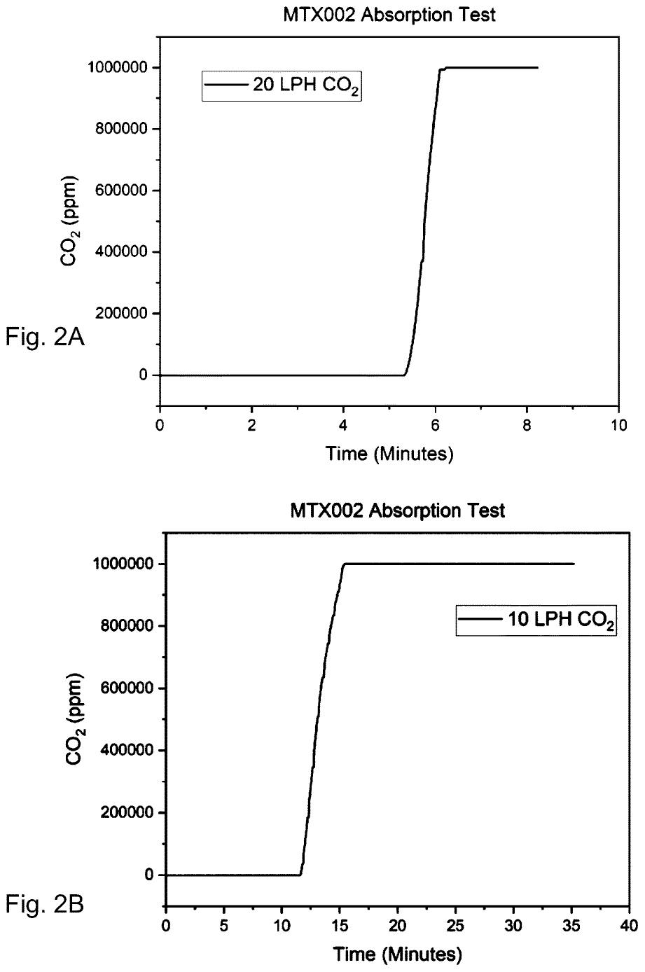

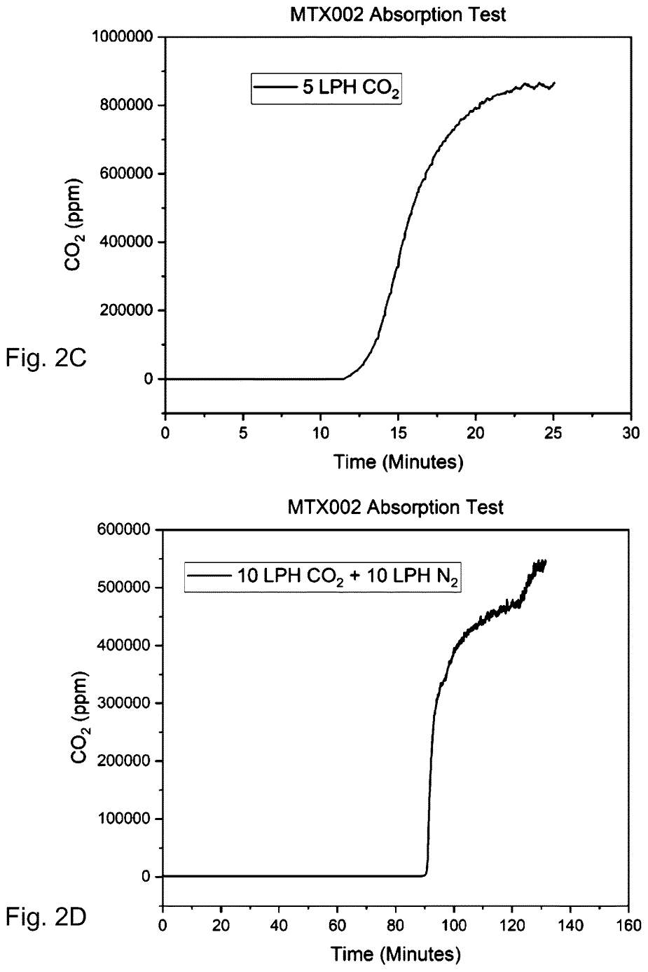

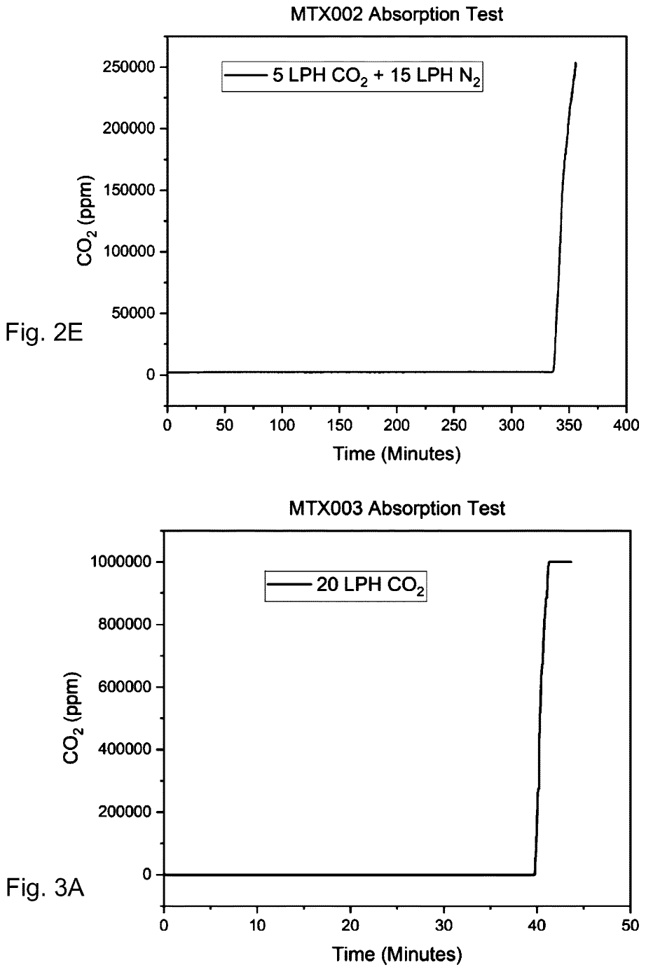

The results of the experiment are shown in FIGS. 2A through 2C.

The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 86.0%, 75.9%, 45.9%, 68.6%, and 94.3%, respectively. The matrix was found to have captured about 80 grams of CO₂ per liter of matrix or about 0.11 grams of CO₂ per gram of matrix.

### Example 3—Silica and Sodium Hydroxide #1

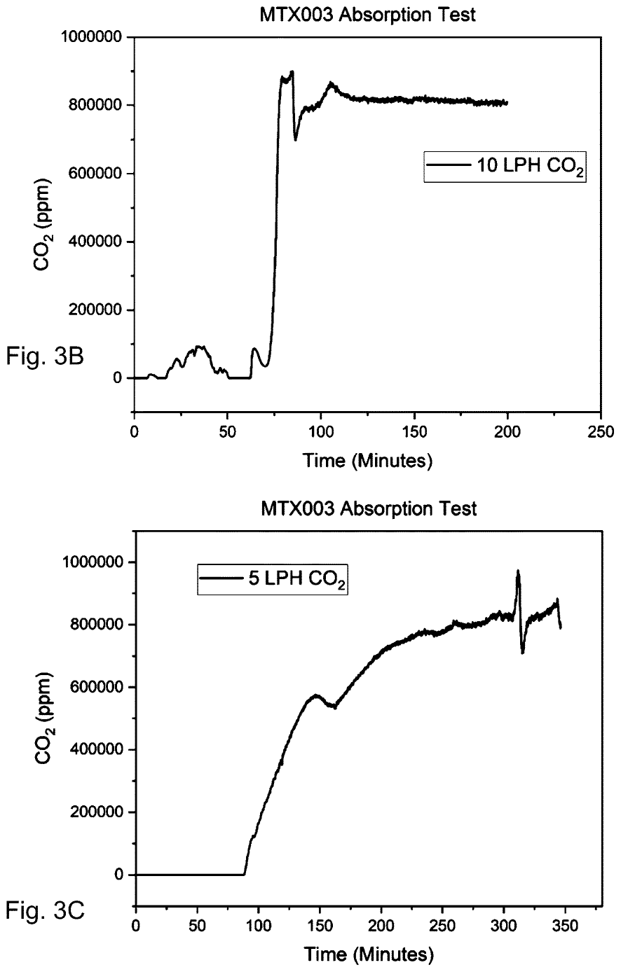

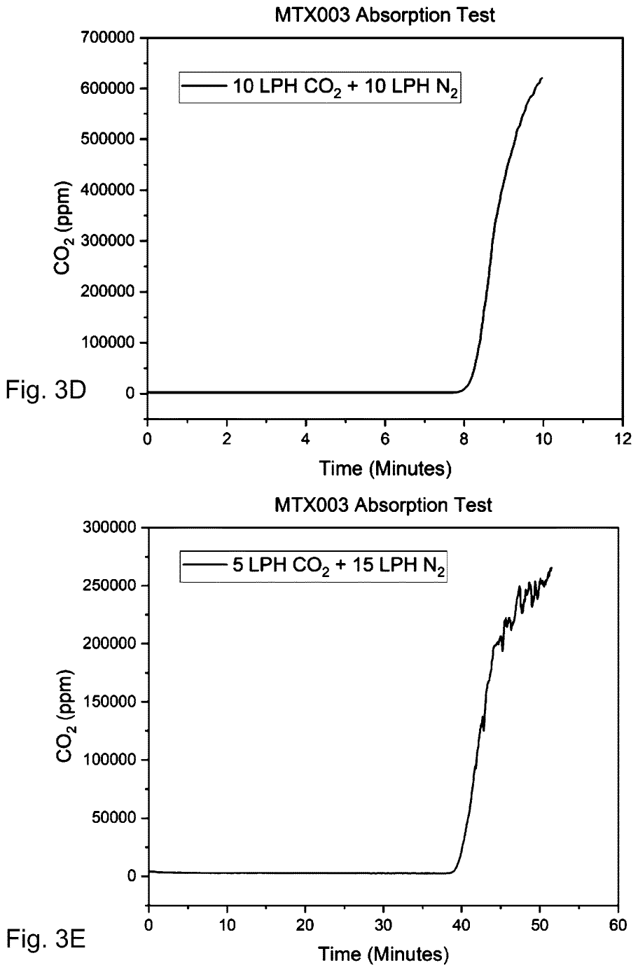

Silica (SiO₂ PPG AB) and sodium hydroxide were obtained from commercial sources. Sufficient NaOH was dissolved in deionized 18-megaohm water to create a 4% weight-per-weight solution (1 Molal NaOH). A composition was prepared with 3 parts silica per 1 part NaOH solution, by volume, using the procedures previously described. The resulting matrix had a specific gravity of 0.76 g/mL. A 250 mm tall test cylinder with an internal diameter of 50 mm was packed with the composition. Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂+10 LPH N₂, and 5 LPH CO₂+15 LPH N₂ through the cylinder were tested. The results of the experiment are shown in FIGS. 3A through 3C.

The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 96.6%, 10%, 26.1%, 79.6%, and 75.8%, respectively. The matrix was found to have captured about 140 grams of CO₂ per liter of matrix or about 0.19 grams of CO₂ per gram of matrix. It was observed that the matrix heated up (to about 130 °C) during sorption. Additionally, the matrix was found to change from white to yellow color.

### Example 4—Silica and 2-Amino-2-Methyl-1-Propanol

Silica (SiO₂ PPG AB) and 2-Amino-2-Methyl-1-Propanol were obtained from commercial sources. A composition was prepared with 2.5 parts silica per 1 part 2-Amino-2-Methyl-1-Propanol, by volume, using the procedures previously described. The resulting matrix had a specific gravity of 0.62 g/mL. A 250 mm tall test cylinder with an internal diameter of 50 mm was packed with the composition.

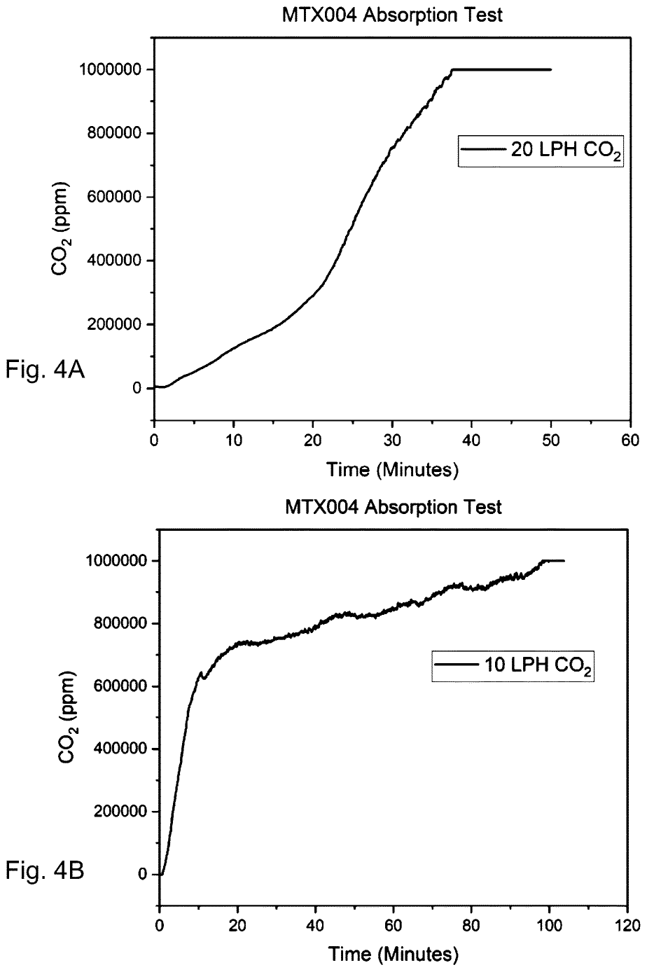

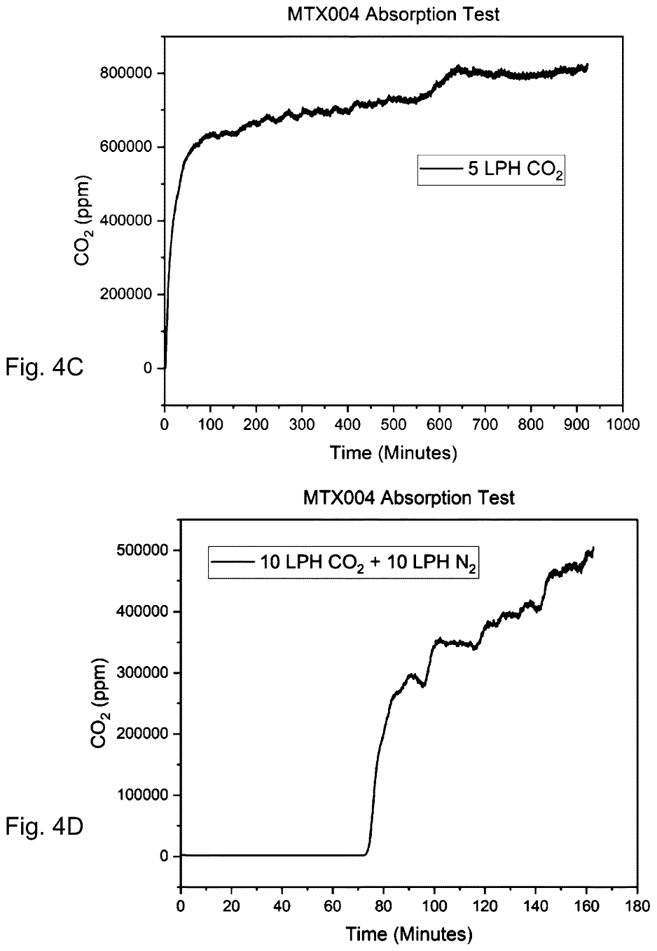

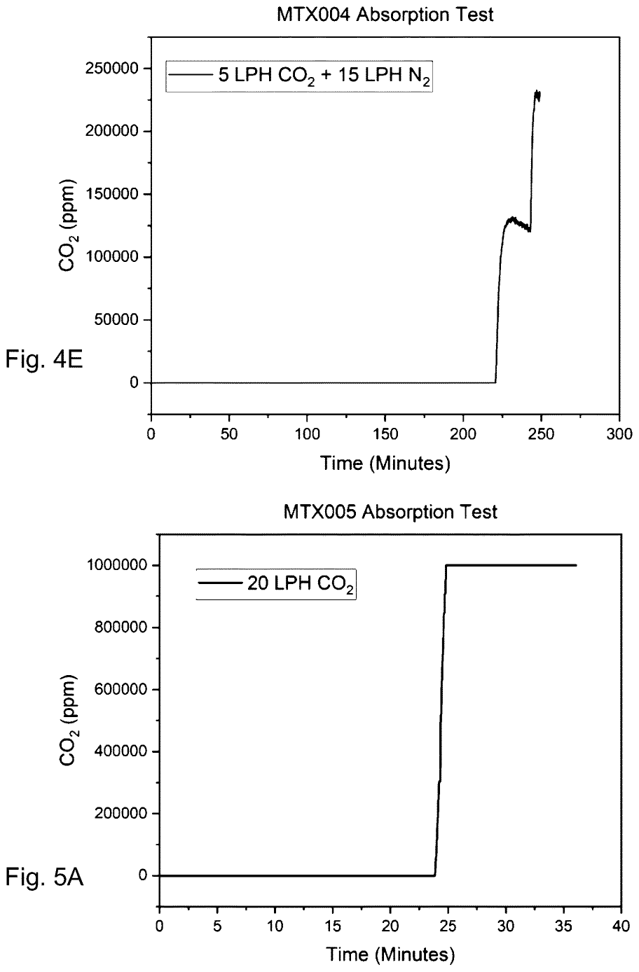

Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂₊₁₀ LPH N₂, and 5 LPH CO₂+15 LPH N₂ through the cylinder were tested. The results of the experiment are shown in FIGS. 4A through 4C.

1102241 The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 0.4%, 0.2%, 0%, 45.3%, and 88.8%, respectively. The matrix was found to have captured about 75 grams of CO₂ per liter of matrix or about 0.1 grams of CO₂ per gram of matrix. It was observed that the matrix heated up (to about 75 °C) during sorption and there was some moisture formation.

### Example 5—Silica and Diethylenetriamine

Silica (SiO₂ PPG AB) and diethylenetriamine were obtained from commercial sources. A composition was prepared with 2.5 parts silica per 1 part diethanyltramine, by volume, using the procedures previously described. A 250 mm tall test cylinder with an internal diameter of 50 mm was packed with the composition.

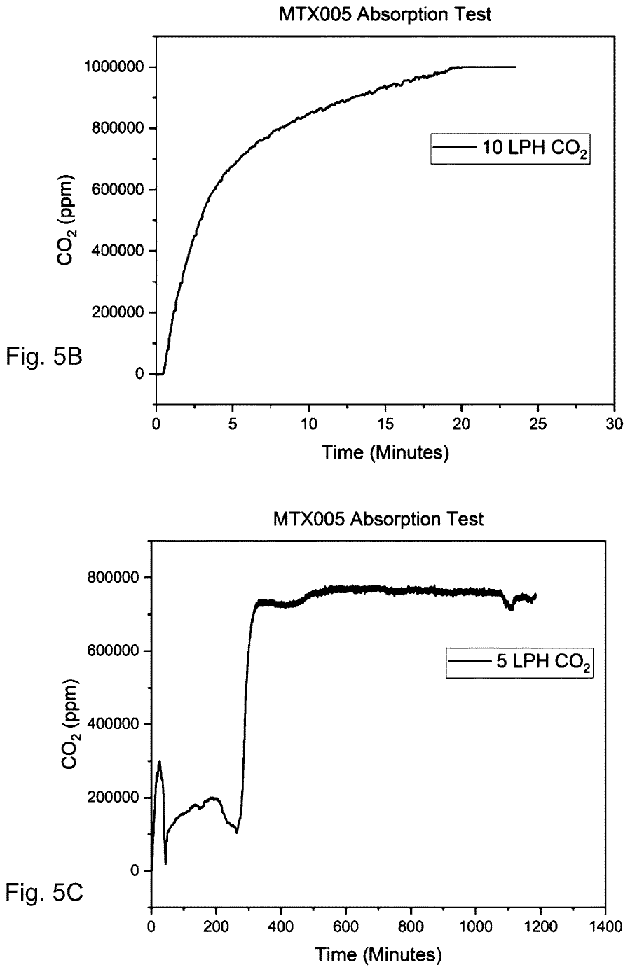

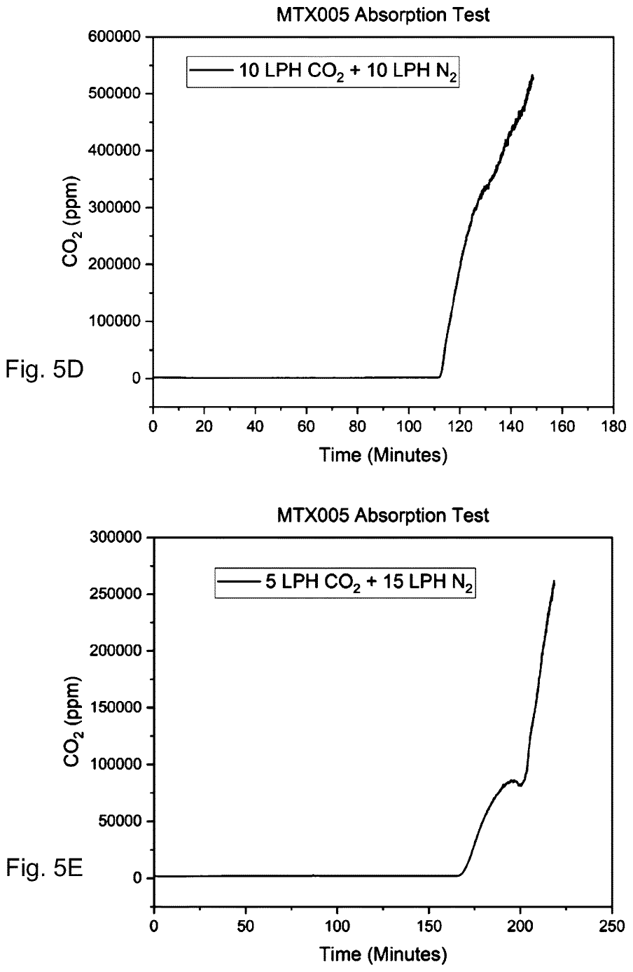

Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂₊₁₀ LPH N₂, and 5 LPH CO₂+15 LPH N₂ through the cylinder were tested. The results of the experiment are shown in FIGS. 5A through 5C.

The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 95.8%, 2.7%, 0%, 75.8%, and 76.6%, respectively. It was also observed that the matrix heated up during sorption.

### Example 6—Attapulgite and Ethanolamine

Attapulgite ((Mg,Al)₂Si₄O₁₀(OH)·4(H₂O)) and ethanolamine were obtained from commercial sources. A composition was prepared with 4.5 parts attapulgite per 1 part ethanolamine, by volume, using the procedures previously described. A 250 mm tall test cylinder with an internal diameter of 50 mm was packed with the composition.

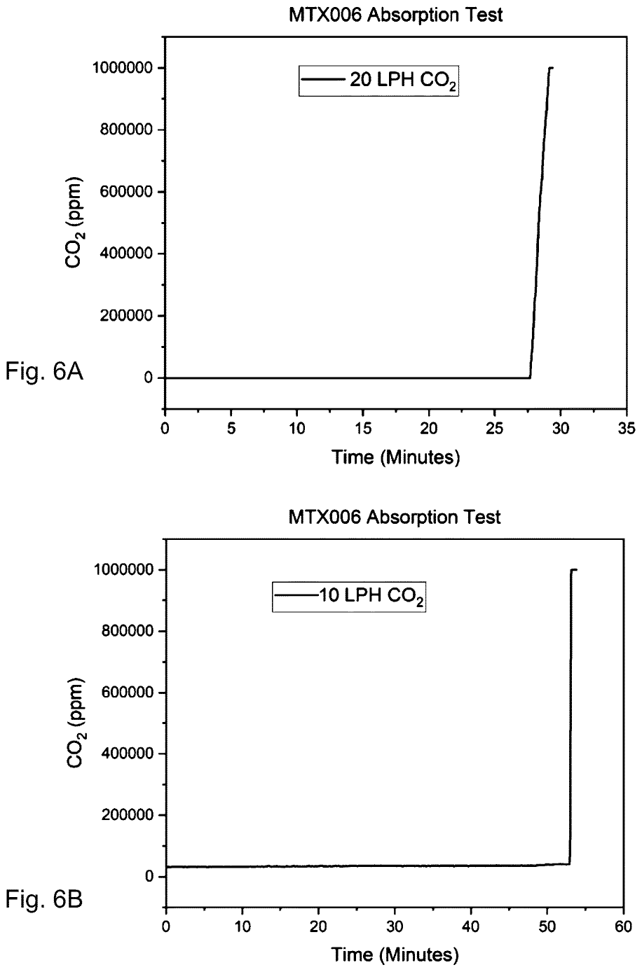

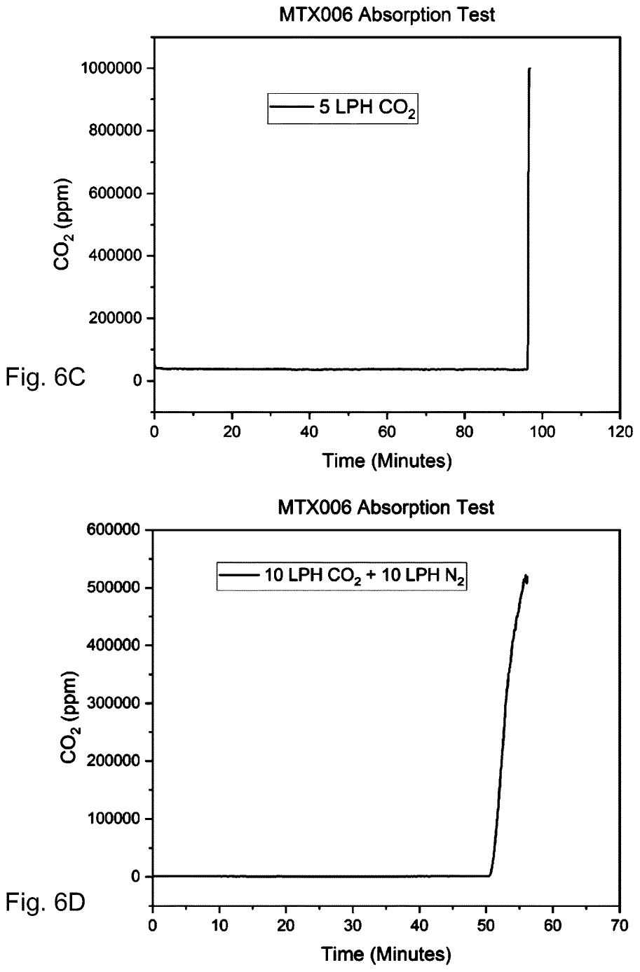

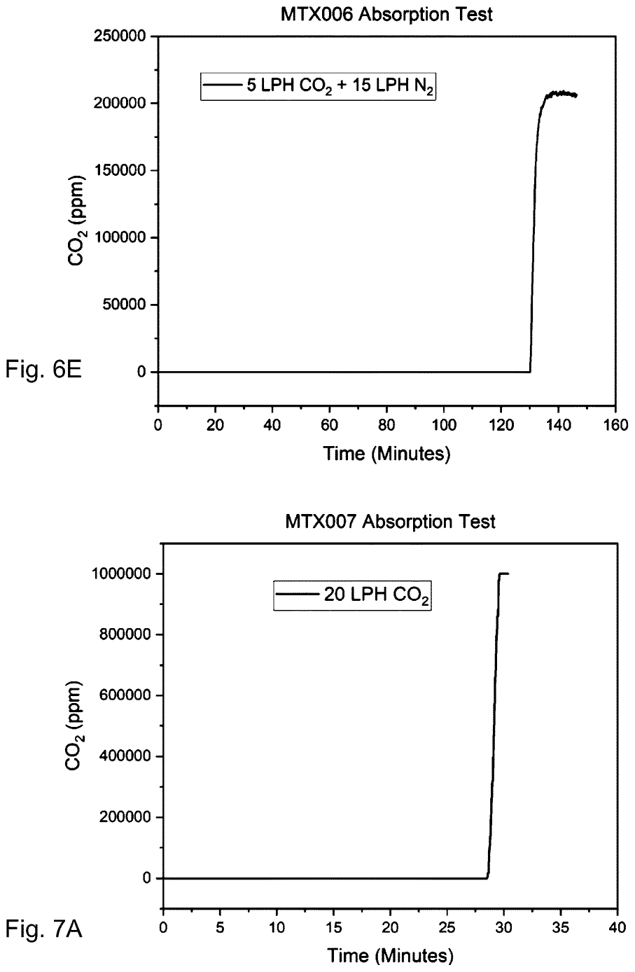

Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂+10 LPH N₂, and 5 LPH CO₂+15 LPH N₂ through the cylinder were tested. The results of the experiment are shown in FIGS. 6A through 6C.

The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 94.6%, 99.4%, 98.9%, 90.5%, and 92.8%, respectively.

### Example 7—Attapulgite and Potassium Hydroxide

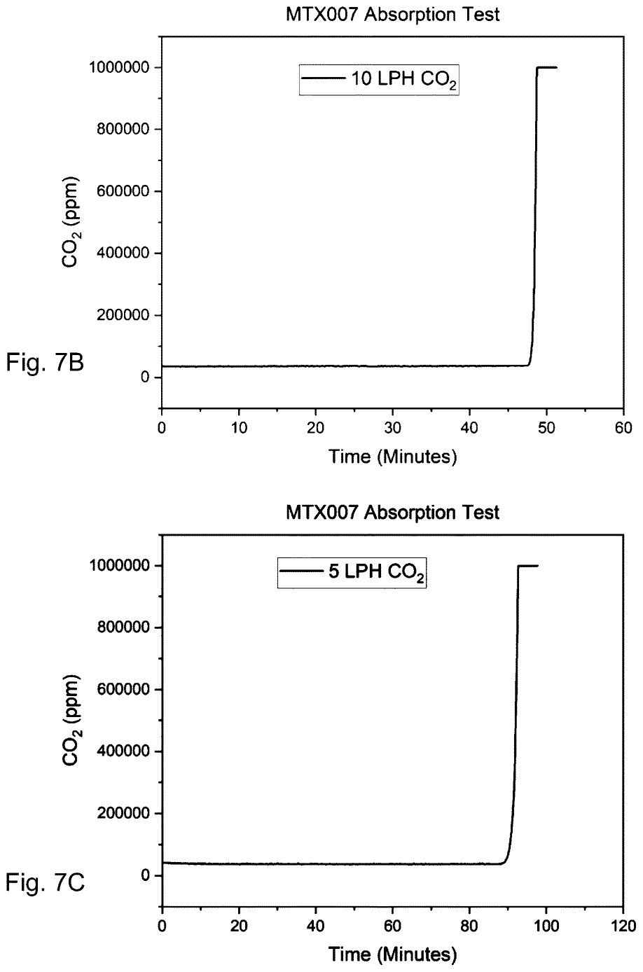

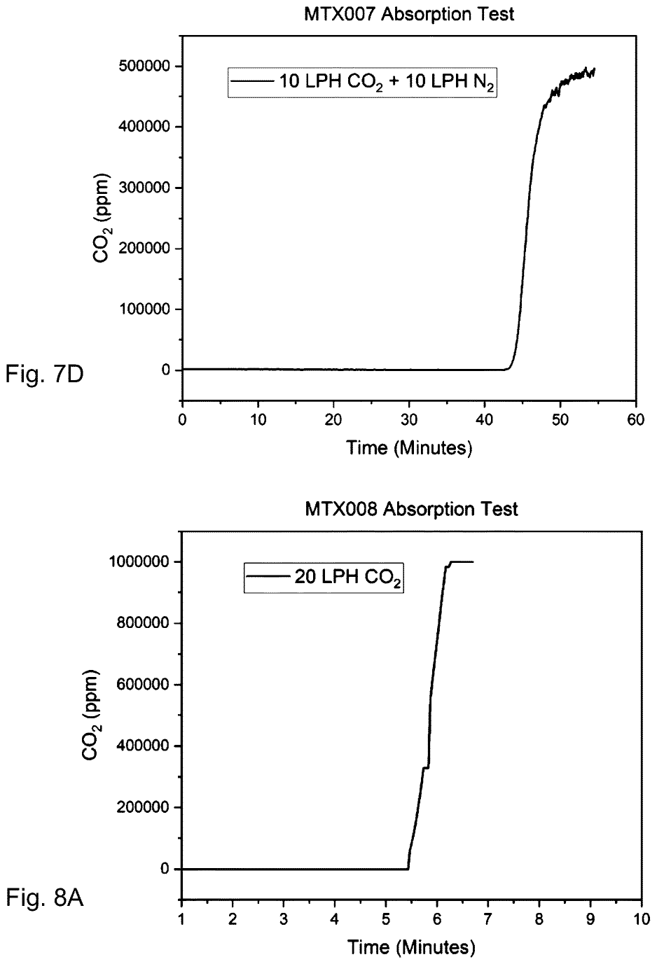

Attapulgite ((Mg,Al)₂Si₄O₁₀(OH)·4(H₂O)) and potassium hydroxide were obtained from commercial sources. Sufficient potassium hydroxide was dissolved in deionized 18-megaohm water to create a 45% weight-per-weight KOH solution. A composition was prepared with 5.8 parts attapulgite per 1 part KOH solution, by volume, using the procedures previously described. A 250 mm tall test cylinder with an internal diameter of 50 mm was packed with the composition. Test gases flowed through the test cylinder until the levels of CO₂ exiting the test cylinder reached a saturation level. Flow rates of 20 LPH CO₂, 10 LPH CO₂, 5 LPH CO₂, and 10 LPH CO₂+10 LPH N₂ through the cylinder were tested. The results of the experiment are shown in FIGS. 7A through 7C.

The absorption time percentages of the 20 LPH CO₂, 10 LPH CO₂, 5 LPH CO₂, and 10 LPH CO₂+10 LPH N₂ tests were found to be 96.1%, 97.8%, 96.1%, and 79.1%, respectively.

### Example 8—Silica and Sodium Hydroxide #2

Silica and sodium hydroxide were obtained from commercial sources. Sufficient NaOH was dissolved in deionized 18-megaohm water to create a 4% weight-per-weight NaOH solution. A composition was prepared with 3 parts silica per 1 part NaOH solution, by volume, using the procedures previously described. A 250 mm tall test cylinder with an internal diameter of 50 mm was packed with the composition.

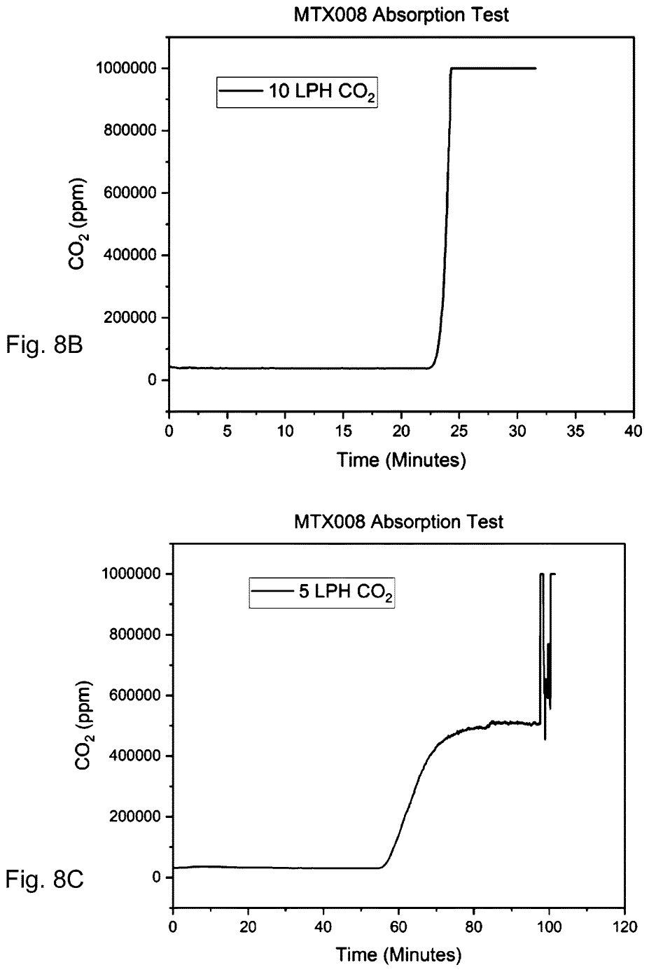

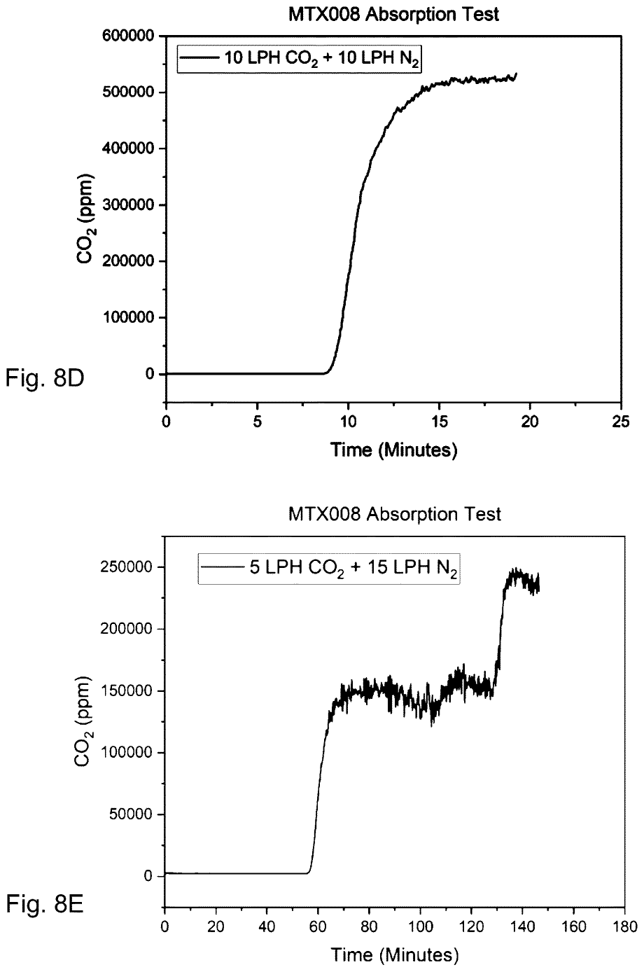

Test gases flowed through the test cylinder until the levels of CO₂ exiting the test cylinder reached a saturation level. Flow rates of 20 LPH CO₂, 10 LPH CO₂, 5 LPH CO₂, 10 LPH CO₂+10 LPH N₂, and 5 LPH CO₂+15 LPH N₂ through the cylinder were tested. The results of the experiment are shown in FIGS. 8A through 8C.

1102361 The absorption time percentages of the 20 LPH CO₂, 10 LPH CO₂, 5 LPH CO₂, 10 LPH CO₂+10 LPH N₂, and 5 LPH CO₂+15 LPH N₂ tests were found to be 84.2%, 92.5%, 65.5%, 56.5%, and 40.6%, respectively.

### Example 9—Calcium Carbonate and Ethanolamine

Calcium carbonate and ethanolamine were obtained from commercial sources. A composition was prepared with greater than 10 parts calcium carbonate per 1 part ethanolamine solution, by volume, using the procedures previously described. A 250 mm tall test cylinder with an internal diameter of 50 mm was packed with the composition.

Test gases flowed through the test cylinder until the levels of CO₂ exiting the test cylinder reached a saturation level. A flow rate of 20 LPH CO₂ through the cylinder was tested. The results of the experiment are shown in FIG. 9.

The absorption time percentage of the 20 LPH CO₂ test was found to be 87.87%.

### Example 10—Silica and Potassium Hydroxide

Silica and potassium hydroxide were obtained from commercial sources. Sufficient potassium hydroxide was dissolved in deionized 18-megaohm water to create a 45% weight-per-weight KOH solution. A composition was prepared with silica and KOH solution using the procedures previously described. It was found that the potassium hydroxide reacted with the silica forming a pasty material.

### Example 11—Sodium Ferrocyanide Decahydrate and Ethanolamine

Sodium ferrocyanide decahydrate and ethanolamine were obtained from commercial sources. A composition was prepared with greater than 16 parts sodium ferrocyanide decahydrate per 1 part ethanolamine, by volume, using the procedures previously described. A 250 mm tall test cylinder with an internal diameter of 50 mm was packed with the composition.

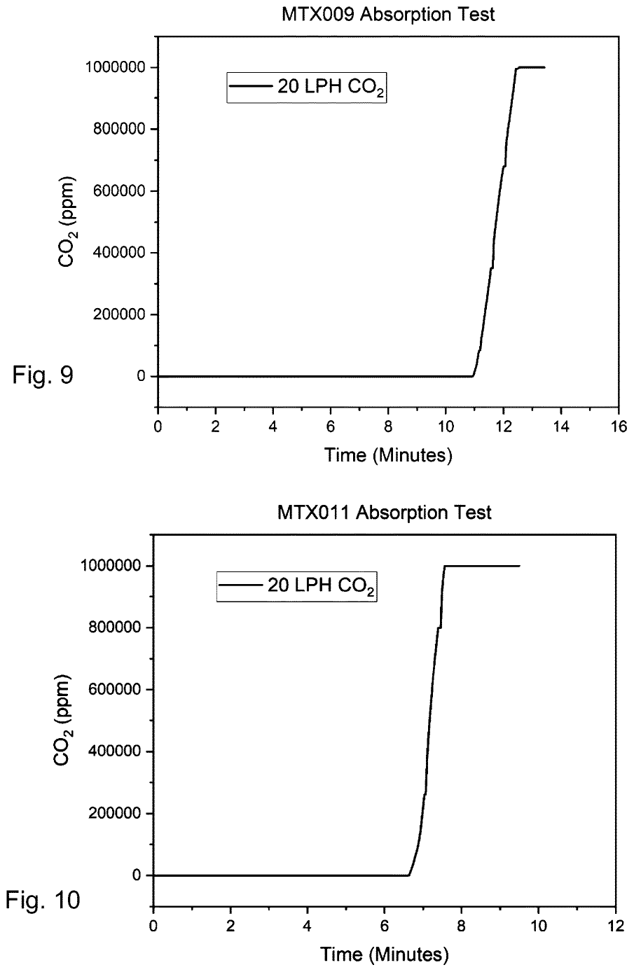

Test gases flowed through the test cylinder until the levels of CO₂ exiting the test cylinder reached a saturation level. A flow rate of 20 LPH CO₂ through the cylinder was tested. The results of the experiment are shown in FIG. 10.

The absorption time percentage of the 20 LPH CO₂ test was found to be 88.2%.

### Example 12—Bentonite and Ethanolamine

Bentonite ((Ca,Na)_{0.33}(Mg,Al)₂Si₄O₁₀(OH)₂·nH₂O) and ethanolamine were obtained from commercial sources. A composition was prepared with greater than 5 parts bentonite per 1 part ethanolamine solution, by volume, using the procedures previously described. A 250 mm tall test cylinder with an internal diameter of 50 mm was packed with the composition.

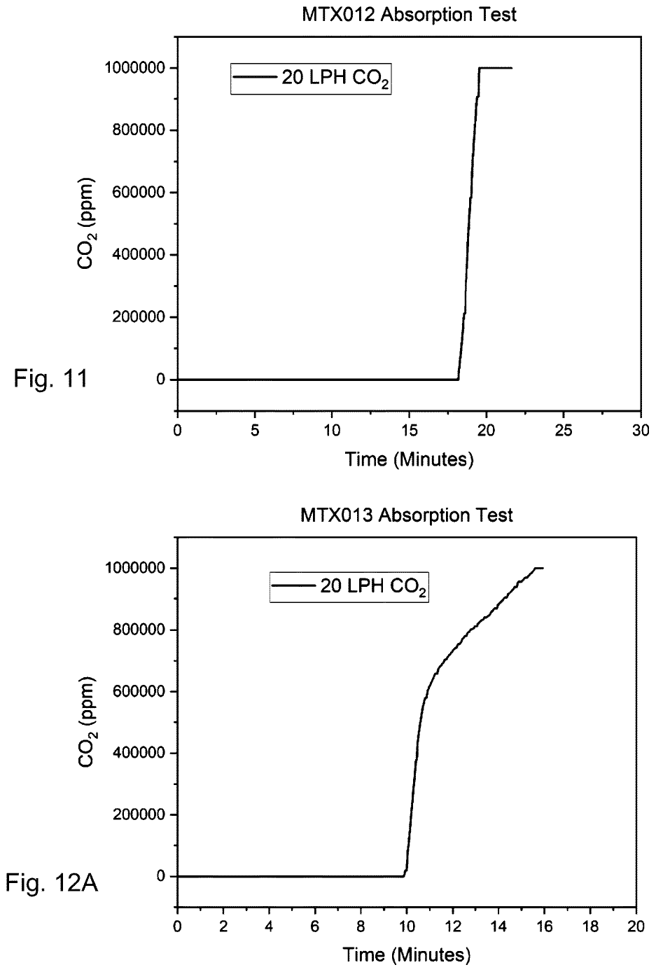

Test gases flowed through the test cylinder until the levels of CO₂ exiting the test cylinder reached a saturation level. A flow rate of 20 LPH CO₂ through the cylinder was tested. The results of the experiment are shown in FIG. 11.

The absorption time percentage of the 20 LPH CO₂ test was found to be 92.9%.

### Example 13—Magnesium Stearate and Ethanolamine

Magnesium stearate and ethanolamine were obtained from commercial sources. A composition was prepared with greater than 6.5 parts magnesium stearate per 1 part ethanolamine solution, by volume, using the procedures previously described. A 250 mm tall test cylinder with an internal diameter of 50 mm was packed with the composition.

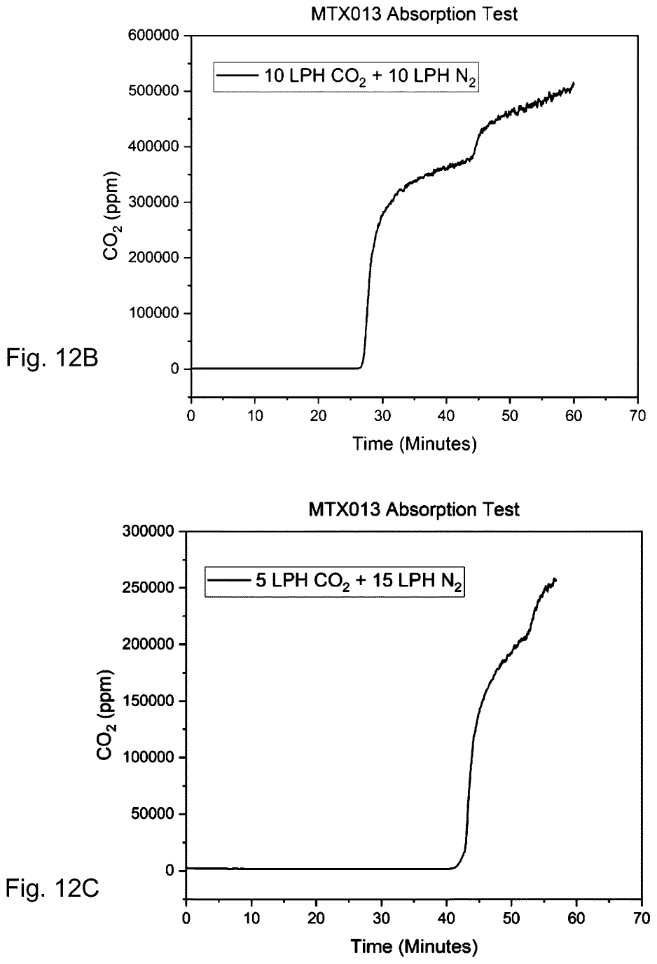

Test gases flowed through the test cylinder until the levels of CO₂ exiting the test cylinder reached a saturation level. Flow rates of 20 LPH CO₂, 10 LPH CO₂+10 LPH N₂, and 5 LPH CO₂+15 LPH N₂ through the cylinder were tested. The results of the experiment are shown in FIGS. 12A through 12C.

The absorption time percentages of the 20 LPH CO₂, 10 LPH CO₂+10 LPH N₂, and 5 LPH CO₂+15 LPH N₂ tests were found to be 63.5%, 44.6%, and 74.3%, respectively.

### Example 14—Sepiolite and Ethanolamine

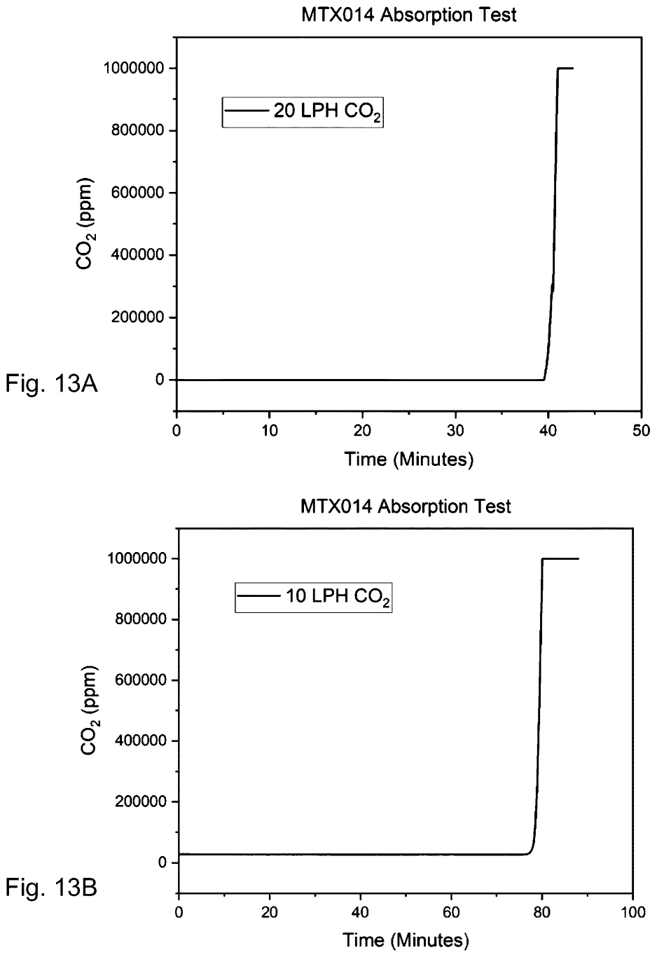

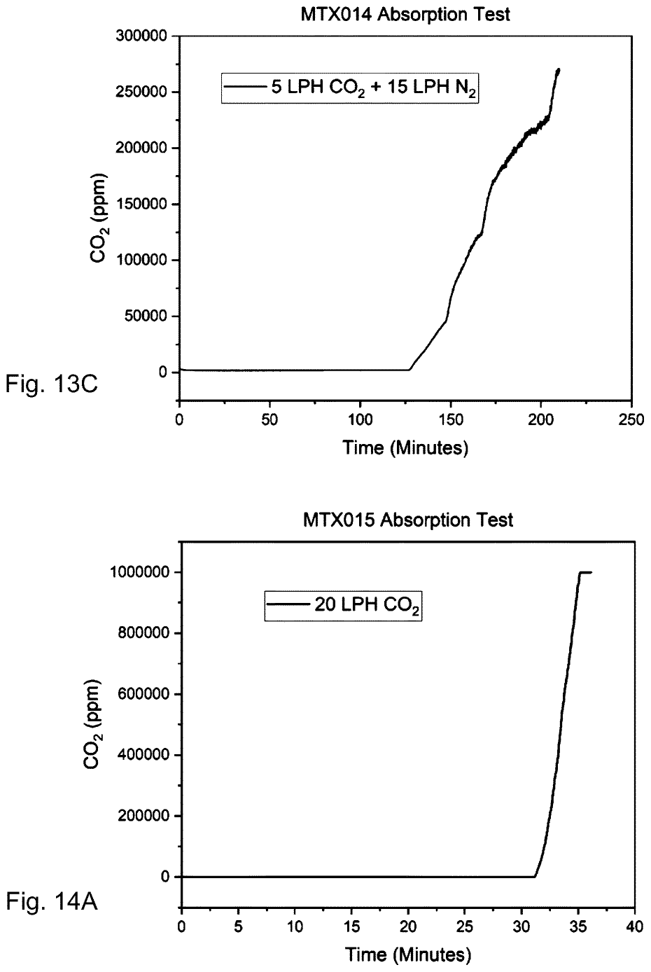

Sepiolite and ethanolamine were obtained from commercial sources. A composition was prepared with 5 parts sepiolite per 1 part ethanolamine, by volume, using the procedures previously described. A 250 mm tall test cylinder with an internal diameter of 50 mm was packed with the composition. Test gases flowed through the test cylinder until the levels of CO₂ exiting the test cylinder reached a saturation level. Flow rates of 20 LPH CO₂, 10 LPH CO₂, and 5 LPH CO₂+15 LPH N₂ through the cylinder were tested. The results of the experiment are shown in FIGS. 13A through 13C.

The absorption time percentages of the 20 LPH CO₂, 10 LPH CO₂, and 5 LPH CO₂+15 LPH N₂ tests were found to be 96.7%, 96.4%, and 61.5%, respectively.

### Example 15—Sepiolite and Potassium Hydroxide

Sepiolite and potassium hydroxide were obtained from commercial sources. Sufficient potassium hydroxide was dissolved in deionized 18-megaohm water to create a 45% weight-per-weight KOH solution. A composition was prepared with 7.5 parts Sepiolite per 1 part KOH solution, by volume, using the procedures previously described. A 250 mm tall test cylinder with an internal diameter of 50 mm was packed with the composition.

Test gases flowed through the test cylinder until the levels of CO₂ exiting the test cylinder reached a saturation level. Flow rates of 20 LPH CO₂ and 10 LPH CO₂ through the cylinder were tested.

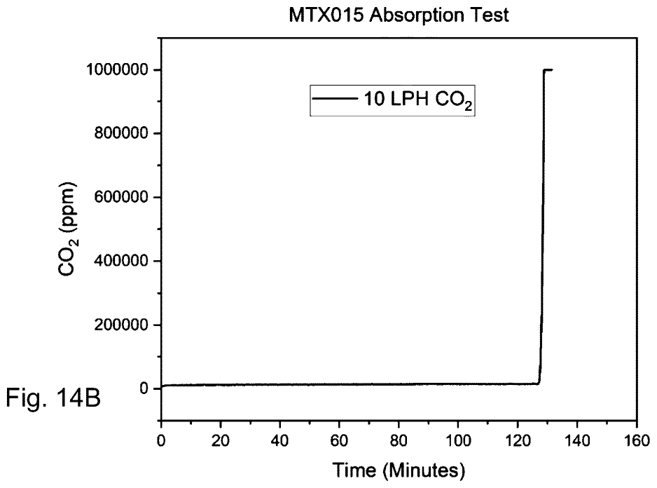

The results of the experiment are shown in FIGS. 14A through 14B.

The absorption time percentages of the 20 LPH CO₂ and 10 LPH CO₂ tests were found to be 88.6% and 97.9%, respectively.

### Example 16—Sepiolite/Silica and Potassium Hydroxide

Sepiolite, silica, and potassium hydroxide were obtained from commercial sources. Sufficient potassium hydroxide was dissolved in deionized 18-megaohm water to create a 45% weight-per-weight KOH solution. A composition was prepared with sepiolite, silica and KOH solution using the procedures previously described. It was found that the potassium hydroxide reacted with the silica and destabilized the matrix.

### Example 17—Silica and Ethanolamine Desorption

A 50 gram silica ethanolamine matrix saturated with CO₂ (see example 2 for further details) was heated to 100 °C (70 °C less than the boiling point of ethanolamine), and the mass of the matrix was measured for one hour at 10 minute intervals.

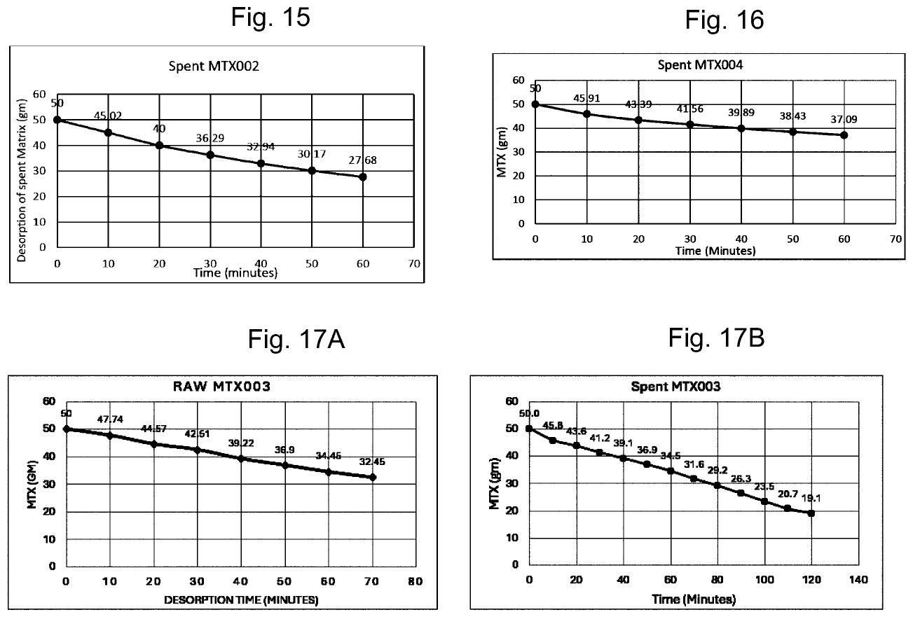

The results of the experiment are shown in FIG. 15.

In the experiment, it was found that desorption occurred at 100 °C with an average CO₂ desorption rate of about 0.37 grams CO₂ per minute. It was observed that the initial density of the composition was 0.83 g/mL and following the one hour desorption the observed density was 0.748 g/mL suggesting that about 11% of the total mass of the composition was CO₂ at saturation. No color change in the composition was observed during desorption.

### Example 18—Silica and 2-Amino-2-Methyl-1-Propanol Desorption

A 50 gram silica 2-Amino-2-Methyl-1-Propanol matrix saturated with CO₂ (see example 4 for further details) was heated to 100 °C (65.5 °C less than the boiling point of 2-Amino-2-Methyl-1-Propanol), and the mass of the matrix was measured for one hour at 10 minute intervals.

The results of the experiment are shown in FIG. 16.

In the experiment, it was found that desorption occurred at 100 °C with an average CO₂ desorption rate of about 0.21 grams CO₂ per minute. It was observed that the initial density of the composition was 0.69 g/mL and following the one hour desorption the observed density was 0.61 g/mL suggesting that about 13% of the total mass of the composition was CO₂ at saturation. No color change in the composition was observed during desorption.

### Example 19—Silica and Sodium Hydroxide Desorption

A 50 gram silica sodium hydroxide matrix saturated with CO₂ (see example 3 for further details) was heated to 100 °C, and the mass of the matrix was measured for one hour at 10 minute intervals. As a control, a 50 gram silica sodium hydroxide matrix that was not saturated with CO₂ was also tested.

1 The results of the experiment are shown in FIGS. 17A and 17B.

In the experiment, it was found that at 100 °C both the control and the saturated matrix lost about 0.26 grams per minute. The estimated mass in the unspent matrix was 0.761 g/mL while the spent matrix was at 0.904 g/mL indicating approximately 9.4 grams of CO₂ in the spent matrix with a mass of 50 g. A color change in the composition was observed during desorption.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

Any use of section headings is intended to aid reading of the document and is not to be interpreted as limiting. Further, information that is relevant to a section heading can occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be conducted in any order without departing from the principles of the invention, except when a temporal or operational sequence is explicitly recited. Furthermore, specified steps can be conducted concurrently unless explicit claim language recites that they be carried out separately. For example, a claimed step of doing J and a claimed step of doing K can be conducted simultaneously within a single operation, and the resulting process will fall within the literal scope of the claimed process.

Unless otherwise indicated, all numbers expressing quantities of components, molecular weights, and so forth used in the specification and claims are to be understood as being modified in all instances by the term “about.” As used herein, in connection with a measured quantity, the term “about” refers to that variation in the measured quantity as would be expected by the skilled artisan making the measurement and exercising a level of care commensurate with the objective of the measurement and the precision of the measuring equipment used. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Those skilled in the art will appreciate that many modifications to the embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of or illustrative embodiments is provided for the purpose of illustrating the principles of the present disclosure and not in limitation thereof and can include modification thereto and permutations thereof. Each embodiment described herein is envisaged to be applicable in each combination with other embodiments described herein.

1. A composition for CO₂ capture, the composition comprising:
a solid matrix comprising:
a porous solid sorbent material with an oil absorption number of at least about 10 mL/100 g; and
a liquid solvent with a CO₂ sorption capacity of at least about 2.5 g CO₂/L at 25 °C,
wherein the liquid solvent is from about 10 percent to about 90 percent of the mass of the solid matrix.

2. The composition of claim 1, wherein the porous solid sorbent material is selected from the group consisting of:
(a) silica, zeolites, metal oxides, ion exchange resins, metal organic frameworks (MOFs), covalent organic frameworks (COFs), calcium silicate, sodium aluminosilicate, magnesium stearate, tricalcium phosphate, sodium bicarbonate, sodium ferrocyanide, potassium ferrocyanide, calcium ferrocyanide, calcium carbonate, magnesium carbonate, and phyllosilicates; or
(b) acrylic ester polymers, activated charcoal, alumina nanoparticles, aluminum phyllosilicates, attapulgite, ball clay, bentonite, calcite, calcium bentonite, calcium carbonate, calcium ferrocyanide, calcium silicate, carbon nanotubes, clay, covalent organic frameworks, diatomaceous earth, dolomite, feldspar, fly ash, fossilized plant materials, Fuller's earth, fumed silica, functionalized silica, Georgia white clay, gypsum, halloysite, hectorite, hormite, illite, ion exchange resins, kaolinite, magnesium carbonate, magnesium stearate, metal organic frameworks, metal oxides, mica, Monterey shale, montmorillonite, opal, palygorskite, perlite, polymeric absorbent resins, polymethyl methacrylate (PMMA), polystyrene divinyl benzene, polystyrene, porous alumina, porous silica, potassium ferrocyanide, pumice, quartz, saponite, sepiolite, silica nanoparticles, silica, slate, smectite, sodium aluminosilicate, sodium bentonite, sodium bicarbonate, sodium ferrocyanide, styrene divinylbenzene (SDB), synthetic zeolite, tobermorite, tricalcium phosphate, vermiculite, and zeolites.

3. The composition of claim 1, wherein the liquid solvent is selected from the group consisting of amines, alkanolamines, ammonia, ionic liquids, Deep Eutectic Solvents, bicarbonates, sulfolanes, amino acids, alkaline solutions, hydroxides, and combinations thereof.

4. The composition of claim 1, wherein the liquid solvent is an aqueous solution with a hydroxide, wherein the hydroxide is selected from the group consisting of sodium hydroxide, potassium hydroxide, magnesium hydroxide, calcium hydroxide, cesium hydroxide, lithium hydroxide, and ammonium hydroxide.

5. The composition of claim 1, wherein the liquid solvent further comprises a CO₂ capture promoter.

6. The composition of claim 1, wherein the composition further comprises a humectant.

7. The composition of claim 1, wherein the solid matrix further comprises an anti-caking agent selected from the group consisting of magnesium carbonate, calcium carbonate, magnesium sulfate, silicon dioxide, magnesium stearate, calcium phosphate, sodium ferrocyanide, potassium ferrocyanide, tricalcium phosphate, powdered cellulose, sodium aluminosilicate, magnesium trisilicate, stearic acid, polydimethylsiloxane, phyllosilicate materials, and combinations thereof.

8. The composition of claim 1, wherein the composition further comprises a hygroscopic sorbent selected from the group consisting of zinc chloride, calcium chloride, potassium hydroxide, sodium hydroxide, magnesium chloride, lithium chloride, iron chloride, copper nitrate, sodium nitrate, ammonium chloride, gold chloride, cellulose based carbon aerogels, Sodium polyacrylate, carboxymethyl cellulose, polyacrylamide, polyvinyl alcohol (PVA), polyethylene glycol (PEG), polyacrylic acid, polyvinylpyrrolidone, hydroxyethyl cellulose, poly N-isopropylacrylamide, poly 2-hydroxyethyl methacrylate and combinations thereof.

9. The composition of claim 1, wherein the liquid solvent is reactive with CO₂ to form a mineralized material within a pore of the porous solid sorbent material.

10. The composition of claim 1, further comprising:
a mineralized material within a pore of the porous solid sorbent material, and
wherein the mineralized material is a product of a reaction between the liquid solvent and CO₂.

11. The composition of claim 1, wherein
(a) the solid matrix has an average granule diameter from about 0.005 mm to about 40 mm, about 0.05 mm to about 4 mm, about 0.1 mm to about 2 mm, about 0.2 mm to about 1 mm, or about 0.5 mm;
(b) the composition is a thin film; or
(c) both (a) and (b).

12. A method of making the composition of claim 1, the method comprising:
combining the porous solid sorbent material with the liquid solvent; and
mixing the combined porous solid sorbent material and liquid solvent to form the solid matrix.

13. A device comprising
an input port;
an output port; and
a first module interposed between the input port and the output port, the first module comprising
a composition for CO₂ capture, the composition comprising:
a solid matrix comprising:
a porous solid sorbent material with an oil absorption number of at least about 10 mL/100 g; and
a liquid solvent with a CO₂ sorption capacity of at least about 2.5 g CO₂/L at 25 °C, wherein the liquid solvent is between about 50 percent to about 70 percent by mass of the solid matrix.

14. The device of claim 13, wherein the device further comprises at least one sensor configured to monitor a CO₂ saturation state of the composition.

15. The device of claim 13, wherein the input port of the device is connected to a carbon dioxide source.

16. The device of claim 13, wherein the device further comprises an expansion zone having a feature selected from the group consisting of a baffle, a fin, and a heat exchange medium; the expansion zone connected to the input port to reduce a temperature of a gas entering the first module and remove moisture from the gas entering the first module.

17. The device of claim 13, wherein the device comprises
second module interposed between the input port and the output port, the second module comprising the composition; and
a valve between the input port and the first and second modules, the valve configured to direct a flow of gas to the first module or the second module.

18. A method of capturing carbon dioxide, the method comprising:
passing a gas mixture comprising CO₂ through a solid matrix, the solid matrix of comprising a porous solid sorbent material with an oil absorption number of at least about 10 mL/100 g, and a liquid solvent with a CO₂ sorption capacity of at least about 2.5 g CO₂/L at 25 °C, wherein
the liquid solvent is between about 10 percent to about 90 percent by mass of the solid matrix;
and absorbing the CO₂ into the liquid solvent.

19. The method of claim 18, wherein the method further comprises forming a mineralized deposit in a pore of the porous solid sorbent material.

20. The method of claim 18, further comprising the step of heating the solid matrix and releasing the CO₂ from the liquid solvent.
